(19) United States
(12) Patent Application Publication
(10) Pub. No.: US 2005/0189901 A1
(43) Pub. Date: Sep. 1, 2005

(54) Stage devices and exposure systems comprising same

(75) Inventor: Keiichi Tanaka, Saitama-city (JP)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/097,036

(22) Filed: Apr. 1, 2005

Related U.S. Application Data
(63) Continuation of application No. PCT/JP03/12136, filed on Sep. 24, 2003.

(30) Foreign Application Priority Data
Oct. 4, 2002 (JP) 2002-292156

(51) Int. Cl. B64C 17/06

(52) U.S. Cl. 318/649

(57) ABSTRACT

Stage devices are disclosed that can be made small and lightweight and that produce little magnetic-field disturbance. As a result, high-precision scan positioning can be performed using them. In an exemplary configuration, a Y-slider driven by a linear motor is deployed on each of two fixed guides that extend in the Y-direction. Between the two Y-sliders are suspended two movement guides that extend in the X-direction. On the movement guide is an X-slider driven by an air cylinder. A stage projects from the X-slider. On the stage is a table driven in the O,-direction (about the Z-axis). The stage device is configured so that a continuous movement (scan) requiring precise positioning is achieved in the Y-direction by linear motors, and intermittent movement and stopping in the X-direction is achieved using an air cylinder.

### CROSS-REFERENCE TO RELATED APPLICATIONS

This is a continuation of International Application No. PCT/JP2003/012136, filed Sep. 24, 2003, which is incorporated herein in its entirety.

### FIELD

This disclosure relates to stage devices for moving and positioning a pattern-master plate (mask, reticle) or sensitive substrate (wafer) or the like, and to exposure systems equipped with such stage devices. More particularly, this disclosure relates to stage devices that produce low magnetic-field disturbance, that can be made small and lightweight, and that can perform high-precision positioning for scanning purposes.

### BACKGROUND

Most of the stage devices for current exposure systems employing light are either so-called “H-type” or “I-type” X-Y stage devices. In these stage devices, a movement guide is suspended between two fixed guides that extend in parallel in a given direction, and a self-propelled stage is configured to travel on the movement guide. The “H” and “I” designations denote the respective shapes of the two fixed guides with the movement guide. These types of stage devices have simple configurations, and are adaptable for smaller size, lighter weight, and higher efficiency. The H-type stage is usually used as a wafer stage in which both axes (X, Y) are long-stroke, while the I-type stage is usually used as a mask stage (reticle stage) that produces a long stroke only in one direction (X-direction or Y-direction).

Linear motors are generally used as the drive actuators for X-Y movement of the stage in H-type and I-type stage devices. In a linear motor, on the self-propelled side of the movement guides, both the stator and a movable element exhibit movement. Hence, H-type or I-type stage devices used as mask stages or wafer stages in electron-beam exposure systems produce magnetic-field fluctuations during exposures. One way of correcting this problem is to place magnetic shielding around the linear motor to shield its magnetic field. However, this remedy adds complexity to the system.

Another type of stage device is a “cross-type” of stage device as disclosed, for example, in FIGS. 1 and 2 of Japan Kôkai Patent Document No. 2002-93686. In a cross-type stage device, two parallel fixed guides extend in both the X- and the Y-directions, respectively. Movement guides that intersect in a cross shape are deployed between the fixed guides so as to be capable of mutually sliding relative to the fixed guides. A stage unit is mounted over the point of intersection of the movement guides. In a cross-type stage device, the linear motor includes permanent magnet(s) and armature coil(s). If permanent magnets that produce highly fluctuating magnetic fields are fixed as stators on a stationary plate in both the X and Y axes, and if armature coils exhibiting comparatively slightly fluctuating magnetic fields are used as movable coils, then fluctuating magnetic fields produced during exposure can be reduced. However, in a cross-type stage device the previously described H-type stage and I-type stage are coupled in the middle. Consequently, such stage devices are excessively large.

Another stage device, that uses a 2-degree-of-freedom (2DOF) linear motor (planar motor), is shown for example in FIG. 8 of Japan Kôkai Patent Document No. 2002-82445. The stage device is either an H-type or I-type stage in which a 2DOF linear motor is situated between two fixed guides that extend parallel in a given direction for driving in one or the other (X or Y) axis. However, the 2DOF linear motor has a special configuration and is comparatively expensive.

Japan Kôkai Patent Document No. H9-34135/1997 discloses a stage device that uses gas bearing(s) and vacuum pad(s) to apply a Z-direction pressurization to a table. The vacuum pad(s) and air bearing(s) are deployed on a stationary plate and are used to impart pressurization in the Z-direction to a moving table. Thus, the mass of the moving table and the like is sustained by the stationary plate. Also, the pressurizing mechanism is simple, so the stage device is readily made lightweight. However, with this stage device, vacuum preloading cannot practically be applied in a vacuum environment. Pressurization alternatively could be applied by a magnetic suction force in place of using a vacuum. However, it is difficult to apply this scheme in a charged-particle-beam exposure system in which avoiding magnetic-field fluctuations is paramount.

With a stage in a scanning-type of exposure system, precise continuous positioning of the stage in the direction of continuous movement (scanning direction) is necessary, while only intermittent movements and frequent stopping are performed in other directions. Hence, extremely precision in the continuous-movement direction is required in the drive mechanism for the scanning stage. In the mechanisms for driving the stage in the other (non-scanning) directions, lightness of weight and a “center-of-gravity” drive are important. “Center-of-gravity” drive means that the center of gravity of the object being driven and the center of the action of the driving force are coincident. It is also desirable that the stage device have a low center of gravity and that vibrations associated with stage movements be blocked.

The present invention, which was devised in view of such problems, provides stage devices that exhibit low magnetic-field disturbance and that can be made small and lightweight for performing high-precision scan positioning. The stage devices can include at least one recoil-cancellation mechanism or a guide-deformation-correction mechanism, or the like. Also provided are exposure systems including such stage devices.

### SUMMARY

In order to resolve the problems described above, a stage device according to a first embodiment is used for driving and positioning a stage within a plane (XY plane). The stage device comprises fixed guides extending in one direction (Y-direction) in the plane; two Y-sliders that slide on the fixed guides; a drive mechanism for the Y-sliders; a movement guide that extends in the other direction (X-direction) of the plane and that is suspended between the two Y-sliders; an X-slider for sliding on the movement guide; a drive mechanism for the X-slider; and a stage unit mounted on the X-slider. The actuator of the drive mechanism for the Y-sliders is a linear motor having permanent-magnet stator(s) secured along the fixed guides. The actuator of the drive mechanism for the X-slider does not produce an electromagnetic force.

Because linear motors exhibit excellent linearity, they allow high-precision positioning control and speed-following control. However, linear motors are expensive, produce leaky magnetic fields, and have low positioning stability. In particular, if the drive mechanism for an X-slider is configured as an ordinary linear motor, the permanent magnets of the linear motor will move together with the Y-sliders or with the movement guides, which produces a large magnetic-field disturbance on the stage. Such a magnetic-field disturbance is intolerable whenever the stage device is used in a charged-particle-beam exposure system. By configuring the actuator for the drive mechanism for the X-slider as one that does not produce an electromagnetic force, such as an air cylinder, magnetic-field disturbances produced on the stage whenever the Y-sliders are being driven are insignificant, which allows high-precision exposures to be performed. Also, because the stators (permanent magnets) of the drive actuator of the Y-sliders are fixed on a stationary plate along the fixed guides, and because they are comparatively distant from the stage unit, adverse magnetic effects can be minimized even if the Y-sliders are driven using a linear motor.

In the stage device described above, a first table (driven in the θ_{z}-direction (about the Z-axis) desirably is mounted on the stage unit, and a second table (driven in the θₓ-direction (about the X-axis), θ_{y}-direction (about the Y-axis), and Z-direction) desirably is mounted on the first table. With such a configuration, a multiple-degree-of-freedom (multi-DOF) stage device can be realized. Also, by providing multiple drive shafts in separate tables, control of the stage and of the tables is facilitated, and precision is enhanced.

In the stage device described above, the moving part(s) of the actuator of the X-slider drive mechanism preferably are guided by one or more gas bearings or air pads. By providing at least one gas bearing in the moving part(s), the stage can be driven with low friction.

Also, in the stage device described above, the non-electromagnetic-force actuator desirably is an air cylinder. Also, an air-pressure-control valve for regulating the air pressure in the air cylinder desirably is mounted on the movement guides. Air cylinders are inexpensive, produce no magnetic-field fluctuations (because they are non-electromagnetic drives), and are stable when stopped. However, because of the compressibility of air used as the active fluid, air cylinders exhibit strong non-linearity caused by lags in transmission of air pressure, and the like. Also, because the volume of a gas chamber varies according to the position of the piston, the gas chamber exhibits fluctuations in performance characteristics, depending upon stage position. To address these issues, an air-pressure-control valve desirably is positioned on the movement guide near the air cylinder for the purposes of reducing the lag of air-pressure transmission and obtaining more responsive stage positioning. An exemplary highly responsive air-pressure-control valve for an air cylinder is a servo-valve driven by a voice-coil motor (VCM). Normally, mounting a servo valve and moving the valve on a movement guide would result in a fluctuating magnetic field occurring on the stage. However, because the magnetic circuit of a VCM is a closed loop, fluctuating magnetic fields that would be caused by movement of the servo valve are sufficiently small compared to the fluctuating magnetic field produced by a linear motor. Consequently, the fluctuating field produced by the VCM can be disregarded.

In the stage device described above, the two Y-sliders are guided by the fixed guides such that only their upper and lower surfaces of the sliders are constrained. By adjusting, relative to each other, the respective propulsion forces produced by the drive mechanisms for the two Y-sliders, the stage can be made capable of rotation in the θ_{z}-direction (about the Z-axis). Thus, the stage can be rotated in the θ_{z}-direction without having to provide a separate table capable of such rotation.

In the stage device described above, secondary fixed guides can be positioned in parallel with the fixed guides. Auxiliary sliders are guided on the secondary fixed guides such that four sliding surfaces (upper, lower, and the two opposing sides) of each of the auxiliary sliders are constrained on the secondary fixed guides by gas bearings. Connection means provide connection of the auxiliary sliders to the Y-sliders. The connection means are flexible in the X-direction and rigid in the Y-direction. More specifically, the connection means can be configured as springs that are flexible in the X-direction and rigid in the Y-direction. Thus, whenever the stage is being driven in the X-direction, stage recoil can be cancelled out by the law of the conservation of momentum. Whenever the X-sliders are being driven in the X-direction, stage recoil normally would be transmitted to the movement guides and the like. However, in this embodiment, because the auxiliary sliders are connected by springs to the movement guides and the like, stage recoil can be canceled by the law of the conservation of momentum, based on the ratio of the mass of the movable parts (the X-sliders and the like) and the mass of the fixed parts (the movement guides and the like). Accordingly, there is no transmission of vibration, due to stage recoil, to the stage device overall, and more accurate stage positioning can be performed.

A first embodiment of an exposure system is used for performing exposures while synchronously scanning two stages in a direction (Y-direction). The system comprises: a mask stage for mounting a mask on which a desired pattern is formed; an illumination-optical system for illuminating the mask with an energy beam; a sensitive-substrate stage for mounting a sensitive substrate onto which the pattern is transferred; a projection-optical system for projecting the energy beam that has passed through the mask so as to form an image on the sensitive substrate; and control means for controlling these components. At least one of the mask stage and the sensitive-substrate stage comprises: fixed guides extending in the Y-direction; two Y-sliders that slide on the fixed guides; a drive mechanism for the Y-sliders; a movement guide that extends in another direction (X-direction) and that is suspended between the two Y-sliders; an X-slider that slides on the movement guide; a drive mechanism for the X-slider; and a stage unit mounted on the X-slider. The actuator of the drive mechanism for the Y-sliders is a linear motor having permanent-magnet stators secured along the fixed guides, and the actuator of the drive mechanism for the X-slider is a non-electromagnetic-force actuator. In other words, movement in the scanning axis (Y-axis) of the sensitive-substrate stage is driven by the fixed-guide linear-motor drive, and movement in the other axes (X-axis, emplacement step axis, and the like) is driven by the non-electromagnetic-force-actuator drive for the movement guide. With such a configuration, there are substantially no electromagnetic-field-generating parts in the non-magnetic-force actuator that moves with the movement guide, and the permanent magnets that are scanning-axis-drive stators are fixed on the stationary plate. Thus, fluctuating magnetic fields that otherwise would be produced during scanning are substantially reduced. This configuration also avoids having to use a special and expensive 2-DOF linear motor. Also, in addition to making the stage device smaller, lighter in weight, and more highly efficient, controllability of the stage device is enhanced. In place of the linear motors, other actuators can be used such as electromagnetic, electrostatic, electrostrictive, and magnetostrictive actuators. Also, non-electromagnetic-force actuators can be used such as air-pressure cylinders and ultrasonic motors and the like.

The stage devices can be further simplified by implementing an H-type structure in which the scanning axis is guided with two fixed guides and the step axis is driven on one movement guide.

In the exposure system described above, a first table (driven in the θ_{z}-direction) desirably is mounted on the stage unit, and a second table (driven in the θₓ-direction, θ_{y}-direction, and in the Z-direction) desirably is mounted on the first table.

A stage device according to a second embodiment is used for driving and positioning a stage, in a given plane (XY plane). The stage device performs continuous movements (scans) requiring precise positioning in one direction (Y-direction), and performs intermittent movements and stopping in the other direction (X-direction). The stage device comprises: two fixed guides extending in the Y-direction; two Y-sliders that respectively slide along the fixed guides; a drive mechanism for the Y-sliders; a movement guide that extends in the X-direction and that is suspended between the two Y-sliders; a stage (X-slider) that slides along the movement guide; and a drive mechanism of the stage. The actuator of the drive mechanism for the Y-sliders is a linear motor, and the actuator of the drive mechanism for the stage is an air cylinder. The linear motor for the Y-slider drive exhibits excellent linearity, which allows scan positioning to be performed with high precision. Driving of the X-slider (stage) along the movement guide, suspended between the Y-sliders, is performed using an air cylinder suitable for achieving reduced mass. Thus, in addition to being able to realize lighter weight in the stage device overall, high acceleration can be realized.

The “air cylinder” in this specification is intended to include cylinders that use a gas other than air as the active medium.

In this second embodiment of a stage device, the fixed guides can include upper and lower guide members that sandwich the Y-sliders from above and below. Also, non-contact gas bearings can be deployed between the two guide members and the upper and lower surfaces of the Y-sliders. This configuration is not one in which the Y-sliders ride on the fixed guides. Rather, the Y-sliders are sandwiched within the fixed guides, which allows the stage device to be made lighter in weight and with a lower center of gravity.

Alternatively, instead of providing a guide mechanism between the fixed guides and the Y-sliders for constraining the sliders in the X-direction, a linear motor (θ_{z}-yaw linear motor) can be attached to the Y-drive linear motor for small-dimension-driving in the X-direction. Attitude control is implemented by the θ_{z}-yaw linear motor for the Y-sliders and movement guide about a direction (Z-direction) that is perpendicular to the XY plane.

The X-sliders are not constrained in the X-direction and can move to some degree (in small dimensions) in that direction. Thus, by driving the θ_{z}-yaw linear motor, and by moving the Y-sliders and the movement guide about a direction (Z-direction) that is perpendicular to the XY plane, the stage attitude can be adjusted about the Z-direction. Thus, θ_{z}-attitude control is possible by the linear-motor-propulsion distribution in a guideless manner without duplicate constriction. It also becomes possible to maintain θ_{z} discretionally.

Further with respect to the second embodiment of a stage device, the stage can be configured so as to be guided on the movement guides in a manner in which the four surfaces (upper, lower, and two side surfaces) are constrained. Thus, opposing high-rigidity support can be realized, and the elastic main axis and center of gravity can be made to coincide, thus facilitating the control of the axes.

Further with respect to the second embodiment of a stage device, at least one exhaust channel can be provided about the periphery of the non-contact gas bearing(s). Thus, gas leaks are diminished, which allows the stage device to be used in a vacuum atmosphere or special atmosphere.

Further with respect to the second embodiment of a stage device, a gas supply, atmospheric gas exhaust, and/or vacuum gas exhaust system can be provided for the non-contact gas bearing(s) in the fixed guides or movement guide. Thus, there is no need to run gas lines to locations other than in the stage device, thereby lessening restrictions on stage movement and enhancing stage controllability.

A third embodiment of a stage device is used for driving and positioning a stage within a plane (XY plane). The stage device comprises: two fixed guides extending in a given direction (Y-direction) in the plane; two Y-sliders that respectively slide along the fixed guides; a drive mechanism for the Y-sliders; a movement guide that extends in the other direction (X-direction) in the plane and that is suspended between the two Y-sliders; a stage (X-slider) that slides along the movement guide; and a drive mechanism for the stage. The fixed guides have upper and lower guide members that sandwich the Y-sliders from above and below, and the guide members receive the drive recoil of the Y-sliders. The stage device further comprises an active countermass that is driven in a direction opposite to that of the Y-sliders. A drive mechanism for the countermass is deployed inside the guide members. The countermass serves as an active recoil-absorbing mechanism that cancels the recoil that develops in conjunction with stage movement, which enhances stage-positioning precision.

A fourth embodiment of a stage device is used for driving and positioning a stage within a plane (XY plane). The stage device comprises: two fixed guides extending in a given direction (Y-direction) in the plane; two Y-sliders that respectively slide along the fixed guides; a drive mechanism for the Y-sliders; a movement guide that extends in the other direction (X-direction) in the plane and that are suspended between the two Y-sliders; a stage (X-slider) that slides along the movement guide; and a drive mechanism for the stage. The fixed guides have upper and lower guide members that sandwich the Y-sliders from above and below. The guide members receive the drive recoil of the Y-sliders. The guide members are non-contact supported against the base of the stage device. The stage device includes a passive countermass mechanism configured such that the guide members move in a direction opposite to that of the Y-sliders due to the drive recoil of the Y-sliders. The passive recoil-disposing mechanism cancels the recoil that develops in conjunction with stage movement, which further enhances stage-positioning precision.

Differences in the characteristics of the active recoil-disposing mechanism and the passive recoil-disposing mechanism, and in the ways in which each mechanism is best used, are as follows. With an active recoil-disposing mechanism, the stroke can be made smaller, and total stage mass reduced. With a passive recoil-disposing mechanism, on the other hand, simultaneity of recoil-disposition can be realized, and power consumption can be reduced. Active recoil-disposition and passive recoil-disposition may be said to exhibit a relationship of mutual duality.

In a stage device as disclosed herein, the movement guide desirably receives the drive recoil of the stage (X-slider), and the stage device desirably further comprises an active countermass, that is driven in a direction opposite to that of the stage, and a drive mechanism for the countermass, deployed inside the guide members. In an alternative configuration, the movement guide can receive the drive recoil of the stage (X-slider), and the movement guide can be non-contact supported against the Y-slider(s). A passive countermass mechanism can be configured such that the movement guide moves in a direction opposite to that of the stage due to the drive recoil of the stage. Thus, in either configuration, the X-slider drive recoil is absorbed, which further enhances stage-positioning precision.

In stage devices as disclosed herein, the actuator of the drive mechanism can be an air cylinder. Thus, because an air cylinder can be made lighter than a linear motor or the like, the drive system on the movement-guide side is made lighter in weight, yielding weight reduction in the stage device overall.

Stage devices as disclosed herein can include auxiliary sliders that move closely along the Y-sliders, wherein a connecting member (pipeline) extending between the Y-sliders connects the auxiliary sliders and the Y-sliders with a fluid flowing to and from an exterior source. With such a configuration, friction that otherwise would arise as the moving stage pulls an air line or the like along with it is reduced, with corresponding enhancement of stage controllability.

The stage device can further include secondary fixed guides for guiding the auxiliary sliders. The secondary fixed guides are deployed in parallel with the fixed guides. An active countermass can be driven by a drive mechanism in a direction opposite to that of the auxiliary sliders. The drive mechanism is deployed inside the secondary fixed guides. The active countermass deployed inside the secondary guides cancels recoil and suppresses vibrations associated with the secondary slider drive, which enhance stage-positioning precision.

The stage device can also include a magnetic shielding structure associated with the linear motor to block disturbing magnetic fields such as high-frequency electromagnetic noise and the like produced by the linear motor.

A fifth embodiment of a stage device is used for driving and positioning a stage within a plane (XY plane). The stage device comprises: two fixed guides extending in a given direction (Y-direction) in the plane; two Y-sliders that respectively slide along the fixed guides; a drive mechanism for the Y-sliders; a movement guide that extends in the other direction (X-direction) in the plane and that is suspended between the two Y-sliders; a stage (X-slider) that slides along the movement guide; and a drive mechanism for the stage. Multiple non-contact gas bearings are deployed, that are aligned in the X-direction, for the movement guide. Gas supply to the non-contact gas bearings is regulated. Thus, sagging of the movement guides by their own weight is corrected.

With such a stage device, by controlling the pressure and flow volume of gas to the non-contact gas bearings, and by subjecting the movement guide to a deliberate moment, the attitude of the movement guide arising from distortion thereof due to its own weight can be corrected.

A second embodiment of an exposure system is used for performing exposures while synchronously and continuously moving (synchronously scanning) the two stages in a given direction (Y-direction). The system comprises: a master-plate stage for mounting a master plate on which a desired pattern is formed; an illumination-optical system for illuminating the master plate with an energy beam; a sensitive-substrate stage for mounting a sensitive substrate onto which the pattern is transferred; and a projection-optical system for projecting the energy beam, that has passed through the master plate, onto the substrate for forming an image on the sensitive substrate. At least one of the master-plate stage and the sensitive-substrate stage comprises a stage device as summarized above.

A third embodiment of an exposure system is used for selectively illuminating a sensitive substrate with an energy beam and forming a pattern on the substrate. In this system, at least one of the sensitive-substrate stage for mounting and moving the sensitive substrate and the master-plate stage for mounting and moving the pattern-master plate is a stage device as summarized above. The energy beam is not particularly limited, and may be a light beam, an ultraviolet beam, an X-ray beam (soft X-ray or EUV or the like), or a charged particle beam (electron beam or ion beam) or the like. The exposure scheme is not limited either, and devices and systems as described herein can be widely applied to reduction-projection exposure, proximity projection, or direct-write schemes or the like.

### BRIEF DESCRIPTION OF THE DRAWINGS

FIG. 1 is a perspective view of the overall configuration of a stage device according to a first embodiment.

FIG. 2 is an elevational section of an X-slider and stage unit of the first embodiment.

FIG. 3 is an elevational section of a Y-slider of the first embodiment.

FIG. 4 is an exploded perspective view of a gas bearing provided in a Y-slider of the first embodiment.

FIG. 5 is an elevational section of an air cylinder provided in an X-slider of the first embodiment.

FIG. 6 is a schematic diagram of a charged-particle-beam (electron-beam) exposure system including a stage device according to the first embodiment.

FIG. 7 is an elevational section of an X-slider and stage unit of a stage device according to a second embodiment.

FIG. 8 is a perspective view of the overall configuration of a stage device according to a third embodiment.

FIG. 9 is an exploded perspective view of a table unit of the third embodiment.

FIG. 10 is a simplified plan view of a stage device according to a fourth embodiment.

FIG. 11 is an exploded perspective view of a table unit of the fourth embodiment.

FIG. 12 is an elevational section of the configuration of an auxiliary slider unit of the fourth embodiment.

FIG. 13 is a perspective view of the overall configuration of a stage device according to a fifth embodiment.

FIG. 14 is a perspective view of the stage device of FIG. 13 with the upper cover removed from the guides and stage(s).

FIG. 15 is a perspective view of a linear motor, Y-slider, movement guide, and stage of the stage device of FIG. 13 (showing a condition in which the fixed guides have been removed).

FIG. 16(A) is a plan view,

FIG. 16(B) is a front elevational view, and

FIG. 16(C) is a side elevational view of the parts shown in FIG. 15.

FIG. 17 is an exploded perspective view of the interior configuration of the linear motor for the Y-slider (Y-axis) drive of the stage device of FIG. 13.

FIG. 18 is a perspective view of a movement guide and stage of the stage device of FIG. 13.

FIG. 19(A) is a plan view,

FIG. 19(B) is a front elevational view, and

FIG. 19(C) is a side elevational view of the movement guide and stage shown in FIG. 18.

FIG. 20(A) is a perspective view depicting stage action, in the X-direction, of the stage device of FIG. 13.

FIG. 20(B) is an action graph of the stage action shown in FIG. 20(A).

FIGS. 21(A) and 21(B) are respective perspective views depicting stage action, in the Y-direction, of the stage device of FIG. 13.

FIG. 21(C) is an action graph of the stage action shown in FIGS. 21(A) and 21(1B).

FIGS. 22(A) and 22(B) are respective perspective views depicting actions of a line carrier of the stage device of FIG. 13.

FIG. 22(C) is an action graph for the actions shown in FIGS. 22(A) and 22(B).

FIG. 23 is a model diagram of an exemplary configuration of a passive countermass mechanism for a Y-direction drive.

FIGS. 24(A) and 24(B) are model diagrams of an exemplary configuration of a passive countermass mechanism for an X-direction drive, wherein FIG. 24(A) is a side elevation and FIG. 24(B) is a plan view.

### DETAILED DESCRIPTION

The present invention is now described, with reference to the accompanying drawings.

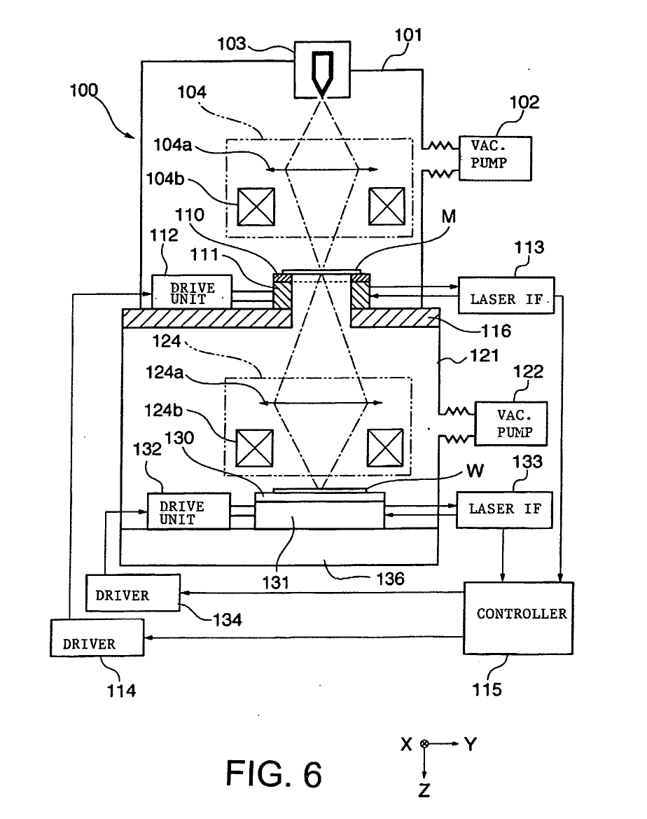

First, referring to FIG. 6, a charged-particle-beam (electron-beam) exposure system 100 is described, in which one or more stage devices according to any of various embodiments described herein can be mounted. The stage devices can be used in an ambient atmosphere or in a vacuum environment, and can be employed in various applications not limited to charged-particle-beam exposure systems. In the upper portion of the exposure system 100 is an optical column (vacuum chamber) 101. To the optical column 101 is connected a vacuum pump 102 that evacuates the atmosphere in the interior of the optical column 101.

At the top of the optical column 101, an electron gun 103 emits an electron beam in a downward direction. Downstream of the electron gun 103 are a mask M and an illumination-optical system 104 which comprises a condenser lens 104a and electron-beam deflector 104b and the like. The electron beam emitted from the electron gun 103 is converged by the condenser lens 104a. The converged electron beam is scanned, in the lateral direction in the drawing, by the deflector 104b, so as sequentially to illuminate subfields of the mask M within the visual range of the illumination-optical system 104. In the drawing, the condenser lens 104a is shown as a single-stage lens, but in an actual illumination-optical system, multiple stages of lenses and beam-forming apertures and the like usually are provided.

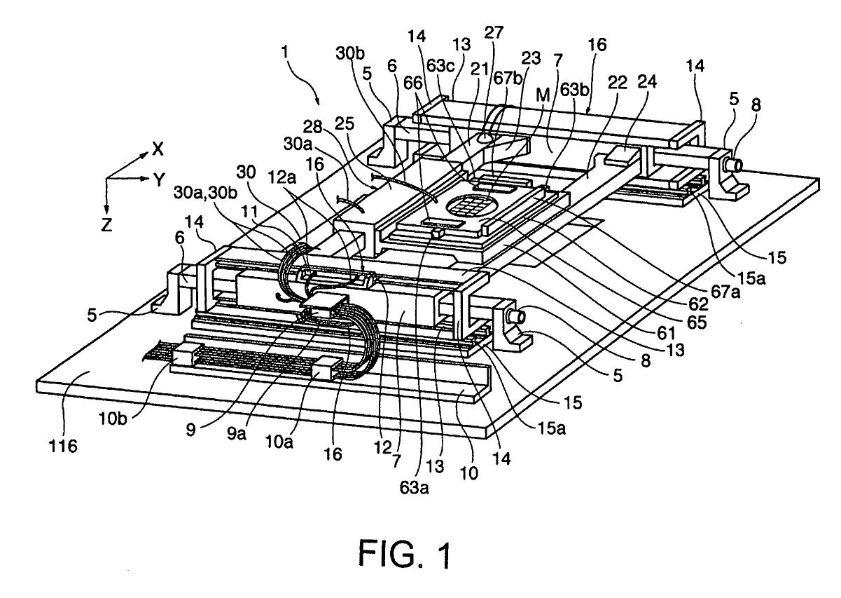

The mask M is secured by electrostatic attraction or the like to a chuck 110 provided on the top of a mask stage 111. The mask stage 111 is mounted on a stationary plate 116. To the mask stage 111 is connected a drive unit 112 indicated at the left in the drawing. (Actually, the drive unit 112 and stage 111 are integral with each other, as shown in FIG. 1, for example.) The drive unit 112 is connected to a controller 115 through a driver 114. Also, a laser interferometer 113 is installed on the side (right side in the drawing) of the mask stage 111. The laser interferometer 1 13 is connected to the controller 115. Accurate positional data for the mask stage 111, as measured by the laser interferometer 113, are input to the controller 115. Commands are sent from the controller 115 to the driver 114, and the drive unit 112 is driven accordingly, to place the mask stage 111 at a target position. Thus, the position of the mask stage 111 is accurately feedback-controlled in real time.

Downstream of the stationary plate 116 is a wafer chamber (vacuum chamber) 121. To the side (right side in the drawing) of the wafer chamber 121, a vacuum pump 122 is connected that evacuates the atmosphere in the interior of the wafer chamber 121. Inside the wafer chamber 121 is a projection-optical system 124 that comprises a condenser lens (projection lens) 124a and a deflector 124b and the like. Downstream of the projection-optical system 124, but still inside the wafer chamber 121, is a wafer W.

An electron beam that has passed through the mask M is converged by the condenser lens 124a and deflected by the deflector 124b as required to form an image of the illuminated portion of the mask M at a prescribed position on the wafer W. In the drawing, the condenser lens 124a is shown as a single-stage lens, but, in actuality, multiple stages of lenses, aberration-correcting lenses, and coils are included in the projection-optical system.

The wafer W is secured by electrostatic attraction or the like to a chuck 130 provided at the top of a wafer stage 131. The wafer stage 131 is mounted on a stationary plate 136. To the wafer stage 131 is connected a drive unit 132 indicated on the left side in the drawing. The drive unit 132 is connected via a driver 134 to the controller 115. Also, on the side (right side in the drawing) of the wafer stage 131 is a laser interferometer 133 that also is connected to the controller 115. Accurate positional data on the wafer stage 131, as measured by the laser interferometer 133, are input to the controller 115. Commands are sent from the controller 115 to the driver 134 to drive the drive unit 132 accordingly, so as to position the wafer stage 131 at a desired target position. Thus, the position of the wafer stage 131 is accurately feedback-controlled in real time.

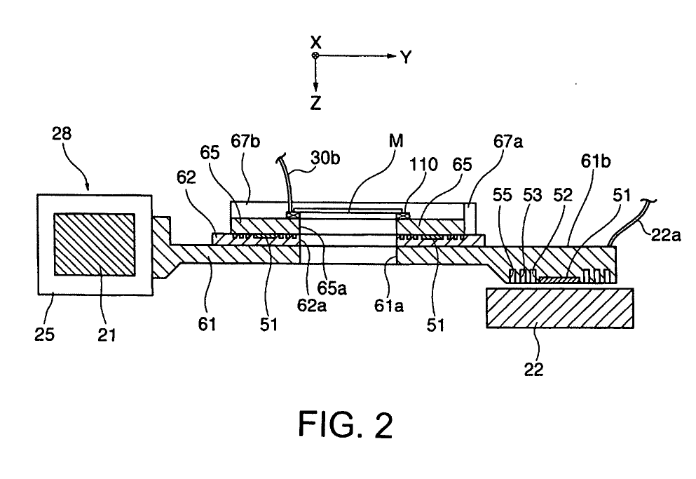

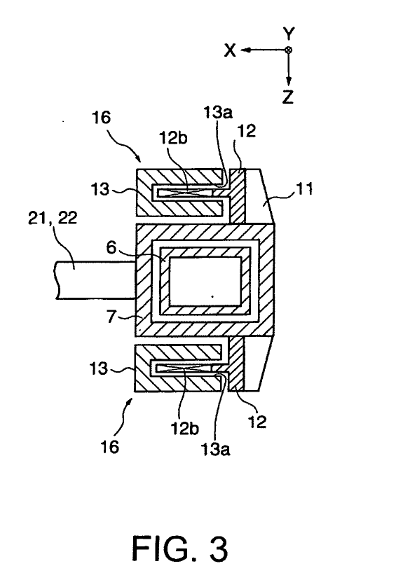

A stage device according to a first embodiment is described with reference to FIGS. 1, 2, and 3. FIG. 1 is a perspective view of the overall configuration of the stage device, FIG. 2 is a side elevational section of an X-slider and stage unit of the stage device, and FIG. 3 is a side elevational section of a Y-slider of the stage device.

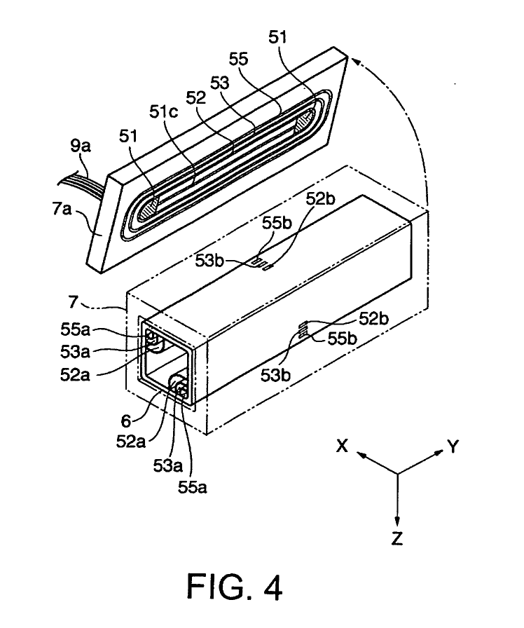

In FIG. 1 the stage device 1 is mounted on a stationary plate 116 (see FIG. 6) that extends in the XY plane. The stage device 1 corresponds to the mask stage 111 in the exposure system of FIG. 6. At two places on the upper surface of the stationary plate 116, two fixed guides 6 are secured that extend parallel to each other in the Y-direction. The fixed guides 6 are respectively secured by two guide-securing brackets 5 so as to be in opposition to each other. The two fixed guides 6 and their peripheral members are configured in basically the same way. Onto the fixed guides 6, Y-sliders 7 of a hollow-box shape are fitted so that they can slide in the Y-direction while being supported by gas bearings (air pads 51, see FIG. 4).

With the stage device in this example, as will be described in detail later while referencing FIG. 4, air pads and guard rings (channels) are formed on the Y-slider 7, while passageways for recovering and exhausting air are formed on the fixed guide 6. On the outer surface of the Y-sliders 7, air lines 9a are provided for supplying air to the air pads of the Y-sliders 7, and connecting wires 12a are provided for supplying drive current to the linear motor 16 and the like. Also, running from the outer surface of the Y-sliders 7 to the air cylinder 28 and stage 61, air lines 30a (omitted partially from the drawing) are deployed for supplying air to the air pads of the X-slider 25, and gas-supply lines 30b (omitted partially from the drawing) are deployed for supplying helium gas to the electrostatic chuck. These lines are bundled by a line-securing member 9. On the stationary plate 116 outboard of the Y-slider 7 side is secured an L-shaped line receptacle 10 that extends in the Y-direction. At two places on the line receptacle 10 are line-securing members 10a, 10b that connect the wires, air lines, and the like secured by the line-securing member 9 to the exterior of the device. Meanwhile, air supplied to the air pads of the Y-sliders 7 (as will be described in detail later while referencing FIG. 4) is exhausted from air ports 8, provided in the fixed guides 6, via recovery and exhaust passageways and the like provided in the fixed guides 6.

Next, referring to FIG. 3, the structure of the fixed guides 6, Y-sliders 7, and linear motor 16 for driving these sliders is described. In the centers of the upper surface and lower surface of each Y-slider 7, T-shaped coil joints 12 are mounted that extend in the Y-direction and that are laid down in the XZ cross section. The T-shaped coil joints 12 are mounted by securing members 11 so as to project toward the inside of the stage. At the tips of the coil joints 12, movable coils 12b (shown only in FIG. 3) of a flat rectangular plate shape are deployed. To the securing members 11 are attached electrical connecting wires 12a (for controlling the movable coils 12b) and hydraulic lines (FIG. 1) for circulating a cooling medium. The connecting wires and hydraulic lines are secured by the line-securing member 9.

Above and below the Y-sliders 7 (but separated by respective gaps) are respective stators 13. The stators 13 are positioned in the drive direction so that the poles of their permanent magnets alternate. (The permanent magnets are of the Nd—Fe—B type or the like). The stators 13 are band-shaped and extend in the Y-direction. The XZ cross-section of each stator has a flattened sideways U-shape. The stators 13 are deployed so that the open sides thereof are oriented to the outside of the stage device. At the upper and lower edges of the stators 13 in the Y-direction, as shown in FIG. 1, sideways-U-shaped stator-securing members 14 secure the two stators 13 to the stationary plate 116 via support plates 15. Between the support plates 15 and the stator-securing members 14 are flat springs 1Sa that allow the stators 13 to move slightly in the Y-direction. Also, while not shown in the drawings, one of the stator-securing members 14 can be secured to the stationary plate 116 by a shock-absorbing material (spring damper or the like), of which an end is grounded to the stationary plate 116 to allow the stators 13 to move slightly in the Y-direction.

The movable coils 12b described above are fitted inside respective channels 13a in the corresponding stators 13. The movable coils 12b and the stators 13 form linear motors 16 for the Y-direction drive. Also, because the point of confluence of the drive forces of the two (upper and lower) linear motors for each of the Y-sliders 7 substantially coincides with the positions of the centers of gravity of the Y-sliders 7, the drive force can be applied at the centers of gravity of the Y-sliders 7. This configuration provides highly precise high-speed position control of the stage. Also, whenever the Y-sliders 7 are driven in the Y-direction, a recoil acts on the stators 13 in the opposite direction. But, the recoil is absorbed by the flat springs 15a provided on the stator-support plates 15, so vibration is not transmitted to the stage. Moreover, in cases in which one of the stator-securing members 14 is secured to the stationary plate 116 by a shock-absorbing material of which an end is grounded on the stationary plate 116, recoil of the Y-sliders 7 is not transmitted to the stage.

Between the two Y-sliders 7 extend movement guides 21, 22 that extend in the X-direction. The movement guides 21, 22 have an open space between them. The energy beam passing through the mask M (see FIG. 6) passes downward through the space between the two movement guides 21, 22. At the connections between the two Y-sliders 7 and the movement guides 21, 22, reinforcing ribs 23, 24, respectively, are provided.

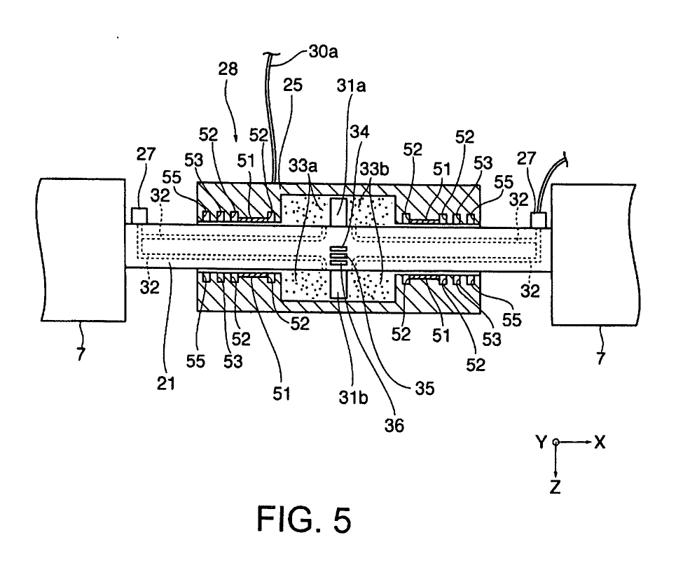

Turning now to the air cylinder 28, a hollow box-shaped X-slider 25 is fitted on the movement guide 21. The movement guide 21 and X-slider 25 configure the air cylinder 28 (described subsequently with reference to FIG. 5) that drives the X-slider 25 in the X-direction. At one end of the movement guide 21 are pressurized-air-control valves 27 (only one of which is shown in FIG. 1) that control the pressure of air delivered to the air cylinder. In this example, the pressurized-air-control valve 27 is a servo-valve driven by a VCM (voice-coil motor). The pressurized-air-control valves 27 desirably are positioned proximally to the air cylinder 28 so as to reduce any lag in pressure transmission.

With the stage device of this embodiment, as will subsequently be described in greater detail with reference to FIG. 4, air pads and guard rings (channels) are formed on the X-slider 25 side, while passageways for recovering and exhausting air are formed on the movement-guide 21 side. On the upper surface of the X-slider 25 is connected an air line 30a for supplying air to the air pads of the X-slider 25. A line receptacle 30, which extends in the X-direction, is secured on the stationary plate 116 on the outside of the X-slider 25. Although not detailed, the line receptacle 30 has the same configuration as the line receptacle 10 situated beside the Y-slider 7 and is secured so that the air lines 30a and supply lines 30b for helium gas supplied to the electrostatic chuck can relax.

The stage 61, shaped as a square flat plate extending in the XY plane, is attached to the side surface on the inward side of the X-slider 25, as shown in FIG. 2. The stage 61 defines a through-hole 61a that permits the downward transmission of an energy beam that has passed through the mask M (see FIG. 6). As shown in FIG. 2, a gas-bearing unit 61b having gas bearings 51 on the lower side thereof is deployed on the side of the X-slider 25 opposite the stage 61. The gas-bearing unit 61b is mounted on the movement guide 22 and is supported by the gas bearings (air pads) 51. The gas-bearing unit can slide in a non-contacting manner on the movement guide 22 in the X-direction. The presence of these gas bearings prevent downward deformation from arising in the side-held, beam-shaped stage 61.

The air pads 51 can be positioned, for example, at two places on the lower surface of the stage 61, separated in the X-direction. In the stage device, as will subsequently be described in greater detail with reference to FIG. 4, air pads and guard rings (channels) are formed on the gas-bearing unit 61b side, while passageways (not shown) for recovering and exhausting air are formed on the movement-guide 22 side. An air line 22a for supplying air to the air pads 51 of the gas-bearing unit 61b is connected at the upper surface of the gas-bearing unit 61b. Air supplied to the air pads of the gas-bearing unit 61b is exhausted via the recovery and exhaust passageways (not shown) provided inside the movement guide 22.

A first table 62, shaped as a square flat plate extending in the XY plane, is mounted on the stage 61. The first table 62 defines a through-hole 62a through which an energy beam from the mask M can pass (see FIG. 6). A second table 65, shaped as a square flat plate extending in the XY plane, is mounted on the first table 62 by gas bearings (air pads 51; see FIG. 2). Piezo actuators 63a, 63b, 63c are provided at three places on the edge surfaces of the second table 65, as shown in FIG. 1. The piezo actuators 63a, 63b, 63c are fastened (by pins or the like, not shown) to the first table 62 in a manner allowing the actuators to turn. The piezo actuators 63a, 63b, 63c can extend and contract on the XY plane. The second table 65 can be made to turn in the θ_{z}-direction (about the Z-axis) by extension and contraction of the piezo actuators 63a, 63b, 63c.

A through-hole 65a extends through the center of the second table 65. An electrostatic chuck 110 (mask-holding device), which secures the mask M, is mounted on the second table 65. A helium-supply line 30b is provided on the upper surface of the second table 65. The helium-supply line 30b supplies helium gas to the electrostatic chuck 110.

This embodiment is of a type in which one mask is mounted in the center portion of the stage 61 and tables 62, 65. Alternatively, the stage device can be configured to hold two masks, aligned in the X-direction. Further alternatively, the stage device can be made so that an even greater number of masks can be mounted on the stage 61. At two places beside the mask M on the second table 65, a mark plate 66 is provided for verifying the position of the second table 65 in the X- and Y-directions. Movable mirrors 67a, 67b are installed at two places on the edge surfaces of the second table 65. The side surfaces on the outer sides of the movable mirrors 67a, 67b are polished with high precision and are used as reflecting surfaces for the laser interferometer 113 or the like shown in FIG. 6.

FIG. 4 is an exploded perspective view of the configuration of a gas bearing provided in the Y-slider of the stage device. In FIG. 4, the outer shape of the Y-slider 7 fitted onto the fixed guide 6 shown in FIG. 1 is indicated by broken lines. The upper surface portion 7a of the Y-slider 7 is shown exploded, above the Y-slider 7. The other surface portions of the Y-slider 7 are configured in the same manner as the upper surface portion 7a. With respect to FIG. 4, a description is given of the configuration of the gas bearings for the fixed guide 6 and Y-slider 7; but, it will be understood that the same configuration can be used for the other gas bearings. The configuration of the gas bearings is not limited to the depicted configuration, however, and any of various other configurations can be used.

At both ends of the sliding surface of the Y-slider upper surface 7a, two air pads 51 comprising a porous material are emplaced. Between the two air pads 51 is a central air-supply channel 51c extending linearly in the longitudinal direction. About the peripheries of the air pads 51 and the air-supply channel 51c are formed, in order, an atmospheric-venting guard ring (channel) 52 for releasing air into the atmosphere, a low-vacuum guard ring 53 for performing low-vacuum exhaust, and a high-vacuum guard ring 55 for performing high-vacuum exhaust. The ends of the guard rings 52, 53, and 55 are formed semicircularly, while the center portions of the guard rings are linear in the longitudinal direction.

Connected at the upper surface of the upper-surface portion 7a of the Y-slider is an air line 9a for supplying air to the air pads 51. Inside the fixed guide 6 are passageways for recovering and exhausting air from the guard rings 52, 53, 55. At the upper left and lower right of the cross-section of the fixed guide 6 shown in FIG. 4, high-vacuum-exhaust passageways 55a are formed so as to extend in the longitudinal direction. Flanking the high-vacuum-exhaust passageways 55a are L-shaped low-vacuum-exhaust passageways 53a that extend in the longitudinal direction. Flanking the low-vacuum-exhaust passageways 53a are L-shaped atmospheric-venting passageways 52a that extend in the longitudinal direction.

Holes 55b, 53b, 52b are formed in the center portion of a side surface of the fixed guide 6, leading to the passageways 55a, 53a, 52a, respectively. These holes 55b, 53b, 52b communicate to the guard rings 52, 53, 55, respectively, and perform air-recovery and air-exhaust. The center portion of each of the guard rings 52, 53, 55 is linear in shape. Accordingly, the holes will not be removed from the guard rings 52, 53, 55 as the Y-slider 7 moves on the Y-axis, ensuring that air recovery and exhaust always is performed from the holes.

Air is supplied from the air line 9a to the air-supply channel 51c, and air is discharged from the air pads 51. The discharged air passes through the atmospheric-venting guard ring 52 and is released into the ambient atmosphere from the atmospheric-venting passageway 52a. Any gas that leaks from the atmospheric-venting guard ring 52 passes to the low-vacuum guard ring 53 and is exhausted via the low-vacuum-exhaust passageway 53a. Any gas that passes to the high-vacuum guard ring 55 is exhausted via the high-vacuum-exhaust passageway 55a. In this manner, air used in the air pads scarcely leaks into the chamber(s) maintained at high vacuum.

FIG. 5 is an elevational section of an air cylinder provided in the X-slider. FIG. 5 shows the movement guide 21 suspended between the two Y-sliders 7 and the X-slider 25 fitted onto the movement guide 21. The air cylinder 28 is configured by the movement guide 21 and the X-slider 25. Air pads 51 are situated in the sliding surfaces of the X-slider 25 for the movement guide 21. The air pads 51 are emplaced in the two (upper and lower) side surfaces (not shown) of the sliding surfaces of the X-slider 25 near the two ends thereof. Air is supplied to the air pads 51 from the air line 30a. About the periphery of the air pads 51 are an atmospheric-venting guard ring 52, a low-vacuum guard ring 53, and a high-vacuum guard ring 55, in that order. Inside the movement guide 21, passageways are formed for recovering and exhausting air from the guard rings 52, 53, 55 (see FIG. 4). In the center of a side surface of the movement guide 21, through-holes 34, 35, 36 are provided for connecting the guard rings to the passageways.

Partition panels 31a, 31b are provided substantially at the center of the movement guide 21. The center part of the X-slider 25 is divided into two gas chambers 33a, 33b by the partition panels 31a, 31b. Inside the movement guide 21, passageways 32 for supplying gas to the gas chambers 33a, 33b are indicated by broken lines. At both outer ends of the passageways 32 are pressurized-air-control valves 27 that control the pressure of the gas supplied to the gas chambers 33a, 33b. By establishing a difference of pressure in the adjacent gas chambers, the X-slider 25 is driven in the X-direction. For example, by making the pressure in the gas chamber 33a higher than in the gas chamber 33b, a difference is produced in air pressure acting on the walls of the gas chambers. The wall of the gas chamber 33a, on which the comparatively high pressure acts, is pushed, thereby causing the X-slider 25 to move relatively to the left, in the figure, on the movement guide 21.

As described earlier, when the stage device in this example is used as a mask stage (reticle stage), the side that is guided by the two fixed guides 6 can be made the scanning axis. Thus, during a scanning movement, the stage 61 will not be twisted, and the controllability of the stage is enhanced. Also, by configuring the air cylinder 28 as the drive mechanism for the X-slider 25, disturbances in the magnetic field on the stage whenever the X-slider 25 is driven can be substantially disregarded, thereby allowing high-precision exposures to be performed. Also, because the stators (permanent magnets) 13 of the linear motor 16 (serving as the drive actuator for the Y-sliders 7) are secured to the stationary plate 116 along the fixed guides 6, and also because the stators are comparatively far removed from the stage unit, adverse magnetic effects can be limited even if the Y-sliders 7 are driven by a linear motor.

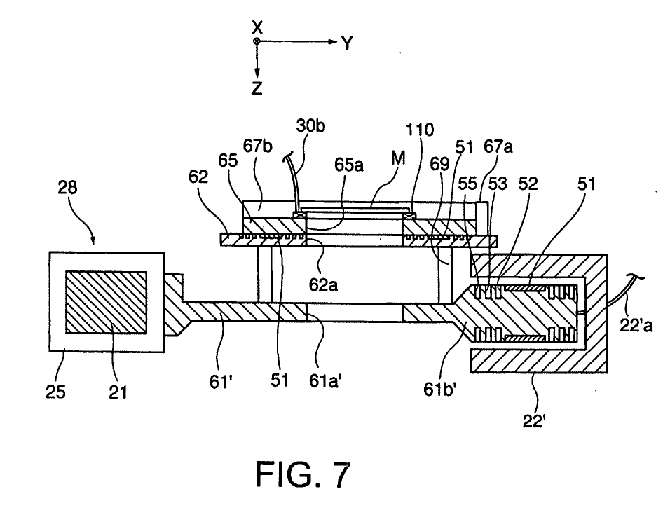

Next, a stage device according to a second embodiment is described with reference to FIG. 7. This is an example in which the top and bottom of the stage 61 of the stage device 1, on the side opposite the movement guide, are configured as constraining guides with gas bearings. FIG. 7 is a side-elevational section of the X-slider and stage unit of the stage device of this embodiment. The configuration of most of the stage device of FIG. 7 is the same as of the stage device 1 shown in FIG. 1. Hence, components that are the same in both embodiments have the same reference numerals and are not described further.

FIG. 7 shows the X-slider 25 fitted onto the movement guide 21. A stage 61′ is attached to a side surface on the inner side of the X-slider 25. On the side (leading-edge part) of the X-slider 25, opposite the stage 61′, is a movement guide 22′ extending in the X-direction. The cross-section of the movement guide 22′ is shaped as a flat sideways “U”.

The stage 61′ defines a through-hole 61 a′ to permit the downward passage of an energy beam that has passed through the mask M (see FIG. 6). A gas-bearing unit 61b′, having gas bearings 51 on the upper and lower surfaces thereof, is provided on the side (leading-edge side) of the X-slider 25 opposite the stage 61′. Two of the air pads 51 can be positioned on each of the upper and lower surfaces, respectively, of the stage 61′, for example. In this stage device air pads and guard rings (channels) are formed on the gas-bearing-unit 61b′ side, and passageways (not shown) for recovering and exhausting air are formed on the movement guide 22′ side. To the gas-bearing unit 61b′ is connected an air line 22a′ for supplying air to the air pads 51. The air supplied to the air pads is exhausted via the guard rings and the recovery and exhaust passageways provided inside the movement guide 22′.

The gas-bearing unit 61b′ is mounted inside the sideways-U portion of the movement guide 22′, supported by the gas bearings (air pads) 51. The gas-bearing unit 61b′ can slide in a non-contacting manner inside the movement guide 22′ in the X-direction. The gas bearings prevent upward and downward deformation in the side-held beam-shaped stage 61′. On the stage 61′, a first table 62 is mounted by four columnar members 69 that extend in the Z-direction, for example. On the first table 62 is mounted a second table 65 on which a mask M is mounted, supported by gas bearings (air pads 51, see FIG. 4). The columnar members 69 are used for raising the bottoms of the first table 62 and the second table 65 so that laser light striking the movable mirror 67a, mounted to the second table 65, is not blocked.

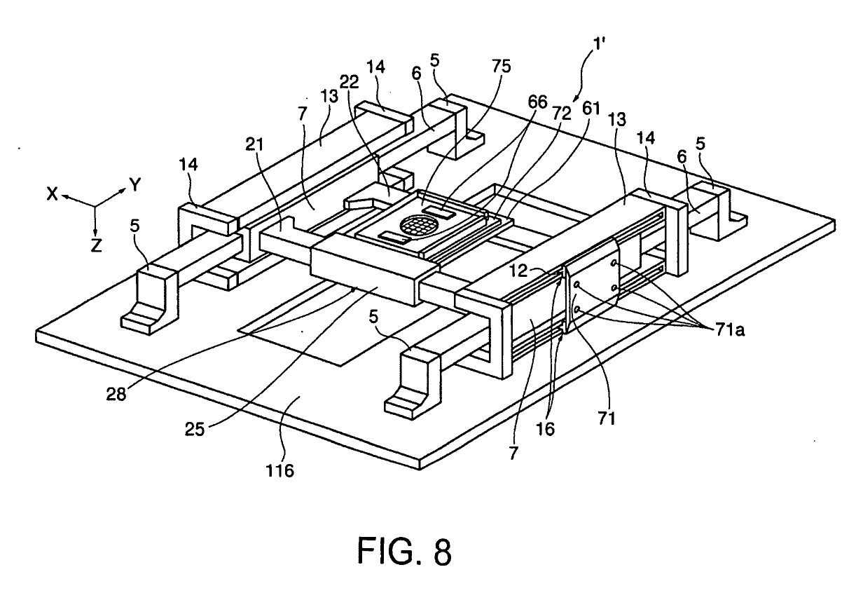

Next, a stage device according to third embodiment is described with reference to FIG. 8. FIG. 8 is a perspective view of the overall configuration of a stage device according to this embodiment. This stage device is an example in which a 4-degree-of-freedom (4-DOF) micro-movement stage is mounted on an XY stage. The configuration of most of this stage device is the same as of the stage device 1 shown in FIG. 1. Hence, components that are the same in both embodiments have the same reference numerals and are not described further. In the depicted stage device, hydraulic lines and connecting wires are omitted from the drawing.

FIG. 8 shows two fixed guides 6 that are mounted on the stationary plate 116 (see FIG. 6) and Y-sliders 7 that are fitted onto the fixed guides 6. The Y-sliders 7 are driven in the Y-direction on the fixed guides 6 by linear motors 16. In this example, moreover, the two coil joints 12 and movable coils 12b (see FIG. 3) of the linear motors 16 are secured to coil-securing plates 71 having a flat-plate shape and having some thickness. The coil-securing plates 71 (only one of which is shown) define four threaded holes 71a, by which the coil-securing plates 71 are secured to the Y-sliders 7 by screws.

Movement guides 21, 22 that extend in the X-direction are suspended between the two Y-sliders 7. The X-slider 25 is fitted onto the movement guide 21, and an air cylinder 28 is configured by the X-slider 25 and the movement guide 21. A stage 61 is mounted to the side surface on the inner side of the X-slider 25. A first table 72 and a second table 75 are mounted on the stage 61, as will be subsequently described in greater detail.

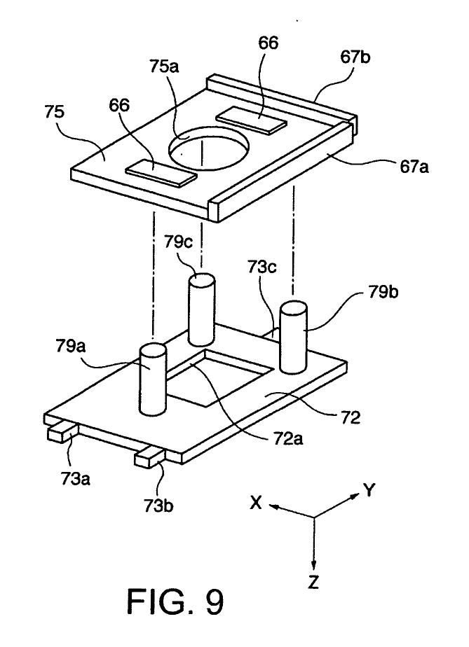

FIG. 9 is an exploded perspective view of the table unit of this stage device. FIG. 9 depicts the first table 72 and the second table 75 mounted on the stage 61. The first table 72 is shaped as a square flat plate extending in the XY plane. The first table 72 defines a central square through-hole 72a through which an energy beam passes that has passed through the mask M. The first table 72 is mounted on the stage 61, supported by gas bearings (air pads 51, not shown, but see FIG. 4). The air pads 51 can be installed at four places on the stage 61, for example. Three piezo actuators 73a, 73b, 73c are mounted at respective locations on the edge surfaces of the first table 72. The piezo actuators 73a, 73b, 73c are fastened to the stage 61 in a manner (e.g., using pins or the like, not shown) allowing the actuators to pivot. Thus, the first table 72 can turn in the θ_{z}-direction (about the Z-axis) by extension and contraction of the piezo actuators 73a, 73b, 73c.

Three piezo actuators 79a, 79b, 79c are mounted, oriented upward, at respective locations on the first table 72. The second table 75, on which the mask M is mounted, is mounted above the three piezo actuators 79a, 79b, 79c. The second table 75 is shaped as a square flat plate extending in the XY plane. The second table 75 defines a central round through-hole 75a through which an energy beam from the mask M can pass. A mark plate 66 is provided at each of two places beside the through-hole 75a on the second table 75. Also, movable mirrors 67a, 67b are installed-at two respective places on the edge surfaces of the second table 75.

To drive the second table 75 in the Z-direction, the piezo actuators 79a, 79b, 79c are caused to extend and contract by exactly the same length. By causing the piezo actuator 79a and the piezo actuators 79b and 79c to extend and contract in a relative sense, the second table 75 can be driven in the θₓ-direction (about the X-axis). For example, by not extending or contracting the piezo actuator 79a or by contracting it while extending the piezo actuators 79b, 79c, the second table 75 can be driven in a negative direction in the θₓ-direction. By causing the piezo actuators 79b, 79c to extend or contract in a relative sense, the second table 75 can be driven in the θ_{y}-direction (about the Y-axis). For example, by not extending or contracting the piezo actuator 79b or by contracting it while extending the piezo actuator 79c, the second table 75 can be driven in the positive direction in the θ_{y}-direction. Furthermore, the three piezo actuators 79a, 79b, 79c can be independently controlled, and the actions described above can be combined, thus imparting 3-DOF position and attitude control to the second table 75. In this example, the micro-movement table has 4 degrees of freedom, namely in the Z, θₓ-direction, θ_{y}-direction, and θ_{z}-direction.

In the embodiment described above, the second table 75 is driven with 3 degrees of freedom by three piezo actuators 79a, 79b, 79c. It alternatively is possible to use a table that is driven with 6 degrees of freedom using six piezo actuators.

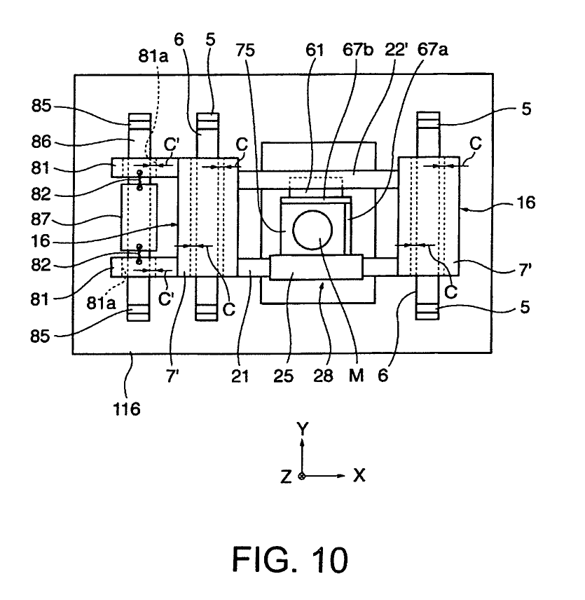

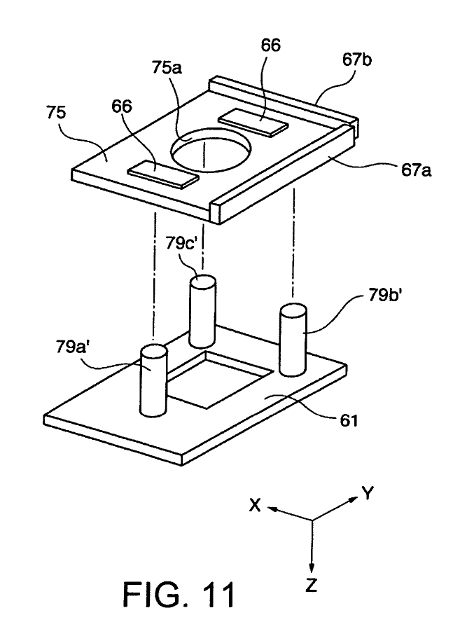

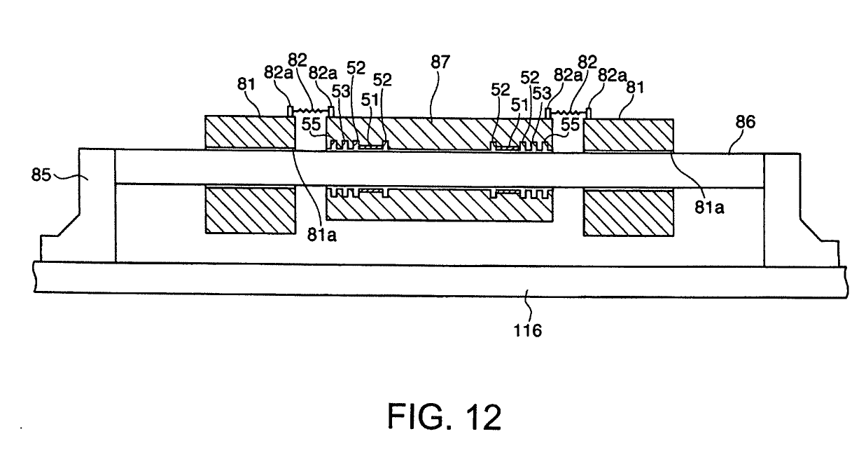

Next, a stage device relating to a fourth embodiment described with reference to FIGS. 10-12. FIG. 10 is a plan view of the stage device, FIG. 11 is an exploded perspective view of the table unit, and FIG. 12 is an elevational section of the auxiliary slider unit of this stage. The stage is turned in the θ_{z}-direction (about the Z-axis) by linear motors deployed on Y-sliders 7′. Also, an auxiliary slider is provided as well as a mechanism for canceling stage recoil. This embodiment has many features that are similar to the first embodiment. Hence, components in this embodiment that are the same as corresponding components in the first embodiment have the same reference numerals and are not described further.

In FIG. 10, two fixed guides 6 are affixed on the stationary plate 116 (see FIG. 6) and Y-sliders 7′ are fitted onto the fixed guides 6. The Y-sliders 7′ are driven in the Y-direction on the fixed guides 6 by linear motors 16. On certain sliding surfaces of the Y-sliders 7′ are gas bearings (air pads 51, not shown but see FIG. 4), specifically only at two places on the top and bottom. At the left and right side surfaces of the sliding surfaces, no gas bearings are present. However, gaps C are provided, which allow the Y-sliders 7′ to exhibit a turning degree of freedom (albeit slight) in the θ_{z}-direction (about the Z-axis), in the XY plane, relative to the fixed guides 6. Between the two Y-sliders 7′ are suspended movement guides 21, 22′ (see FIG. 7) that extend in the X-direction. An X-slider 25 is fitted onto the movement guide 21, and an air cylinder 28 is configured. The stage 61 is attached to the side surface on the inner side of the X-slider 25. The stage 61 is driven in the X-direction on the movement guides 21, 22′ by the air cylinder 28.

Three piezo actuators 79a′, 79b′, 79c′ are mounted, oriented upward, at three respective locations on the stage 61, as shown in FIG. 11. The second table 75 is mounted on the upper ends of the piezo actuators 79a′, 79b′, 79c′, and the mask M is mounted to the second table 75. By causing the piezo actuators 79a′, 79b′, 79c′ to extend and contract, the second table 75 is driven in the θₓ-direction (about the X-axis), in the θ_{y}-direction (about the Y-axis), and in the Z-direction. In this embodiment, moreover, there is no first table that turns in the θ_{z}-direction (about the Z-axis) (see the first table 72 shown in FIG. 9).

In this embodiment thick arms 81 extend in the X-direction and are attached to the edge surfaces on the outer sides of one of the two Y-sliders 7′ (i.e., the one on the left side in FIG. 10). As shown in FIG. 12, the arms 81 define holes 81a that pass through in the Y-direction. Into the holes 81 are fitted a secondary fixed guide 86. As shown FIG. 10, a gap C′ exists between the secondary fixed guide 86 and the left and right side surfaces of the sliding surfaces of the holes 81 a. Thus, the arms 81 and the Y-sliders 7′ and the like have a turning degree of freedom in the θ_{z}-direction (about the Z-axis) in the XY plane relative to the fixed guides 6 and 86.

The secondary fixed guide 86 is basically configured in the same way as the fixed guides 6, and is secured to the stationary plate 116 by two guide-securing members 85. An auxiliary slider 87 is fitted on the secondary fixed guide 86 between the two arms 81. The auxiliary slider 87 is basically configured in the same way as the Y-sliders 7 shown in FIG. 1, and is provided with gas bearings (air pads 51, not shown but see FIG. 4) at two places each, above and below, left and right, on the sliding surfaces thereof. Accordingly, the auxiliary slider 87 has no turning degree of freedom in the θ_{z}-direction (about the Z-axis) in the XY plane relative to the secondary fixed guide 86.

The auxiliary slider 87 and the two arms 81 are coupled, respectively, by springs 82. The springs 82 are secured on the auxiliary slider 87 and the two arms 81 by spring-securing hardware 82a. For these springs 82, parallel flat springs can be used that are flexible (capable of extension and contraction) in the X-direction and rigid (incapable of extension and contraction) in the Y-direction. Thus, whenever the Y-sliders 7′ are driven in the Y-direction, the auxiliary slider 87 will also be driven in like manner in the Y-direction by the springs 82. Whenever the X-slider 25 is driven in the X-direction, on the other hand, stage recoil will be transmitted to the movement guide 21 and the like by the air cylinder 28. When the movement guide 21 receives the recoil, the stage recoil will also be transmitted to the Y-sliders 7′ connected to the movement guide 21, to the movement guide 22′, and to the arms 81, causing these components to move in the X-direction. Due to movement of the arms 81 and the like, the springs 82 are subjected to a force in the X-direction. However, because the springs 82 are flexible (capable of extension and contraction) in the X-direction, and because the four surfaces of the auxiliary slider 87 are constrained, stage recoil can be cancelled according to the law of the conservation of momentum, based on the mass ratio between the mass of the movable parts (the X-slider 25 and the like) and the stationary parts (the movement guide 21 and the like). In this case, the movement guide 21, the Y-sliders 7′, the movement guide 22′, and the arms 81 and the like act as a recoil-disposing mechanism (countermass).

This stage device can be driven in the O,-direction (about the Z-axis) in the following manner. In this embodiment it is possible to effect a turning (θ-direction) motion by altering the propulsion balance between the Y-slider 7′ linear motors 16 that are positioned in opposition. For example, by driving the linear motor 16 on the right side in FIG. 10 in the negative Y-direction, and driving the linear motor 16 on the left side in FIG. 10 in the positive Y-direction, the second table 75 can be turned in the positive θ_{z}-direction (about the Z-axis). However, the turning angle is minute because it is constrained by the gap intervals between the Y-sliders 7′ and the fixed guides 6, and between the arms 81 and the secondary fixed guide 86. By adjusting the propulsion balance between the linear motors 16, accurate stage drive can be performed with little shaking or the like.

In the foregoing, stage devices and the like relating to embodiments shown in FIGS. 1-12 were described. However, the present invention is not limited to or by those embodiments, and stage devices can be modified as will now be described. The stage devices described above also can be applied to a wafer (sensitive-substrate) stage 131 (see FIG. 6), for example. In a wafer stage, there is no need for the through-holes in the Z-direction (e.g., the through-holes 72a, 75a in FIG. 9 and the like) that were provided in the stages and tables described above. However, such holes may be made in the interest of making the stages and the like lighter in weight.

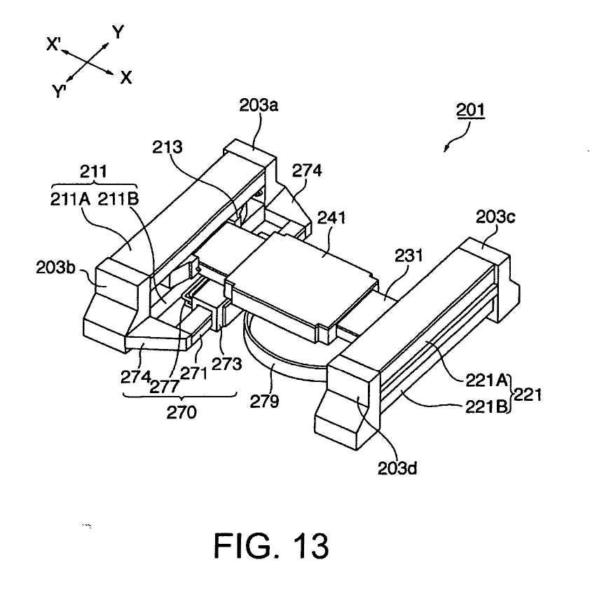

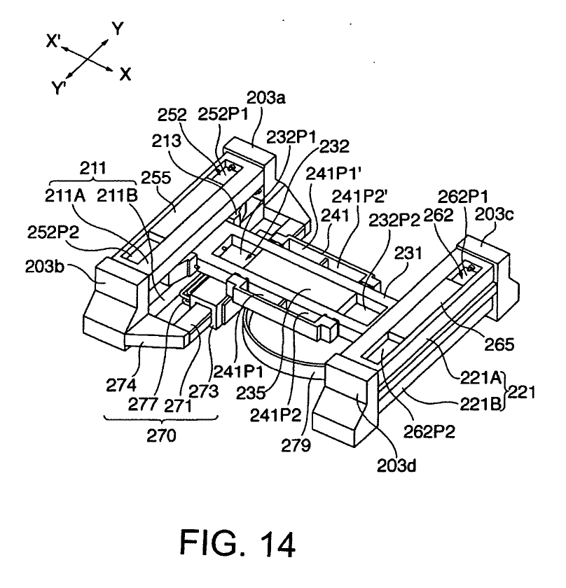

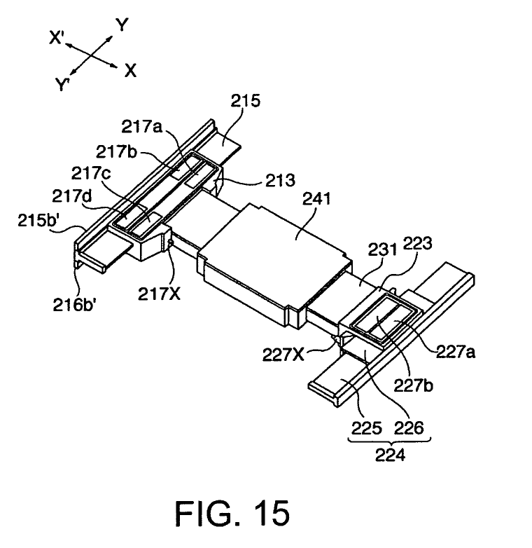

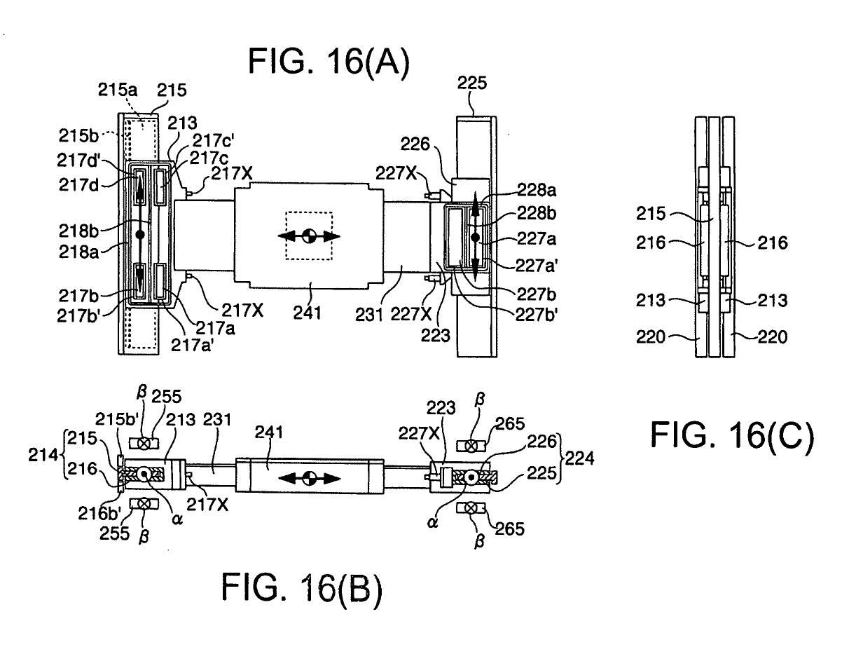

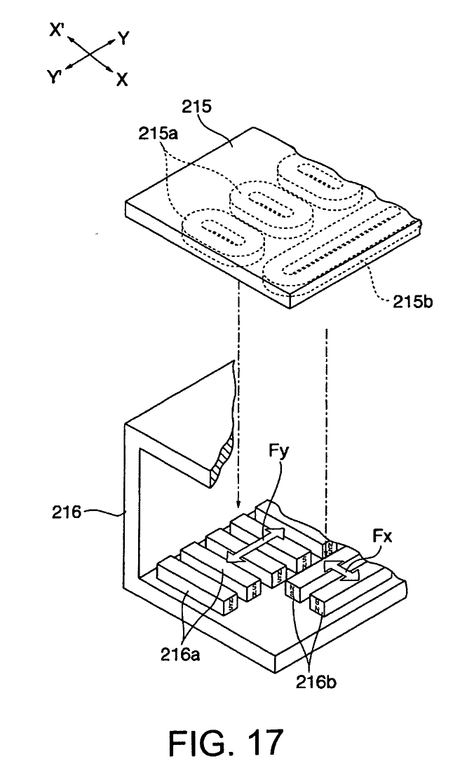

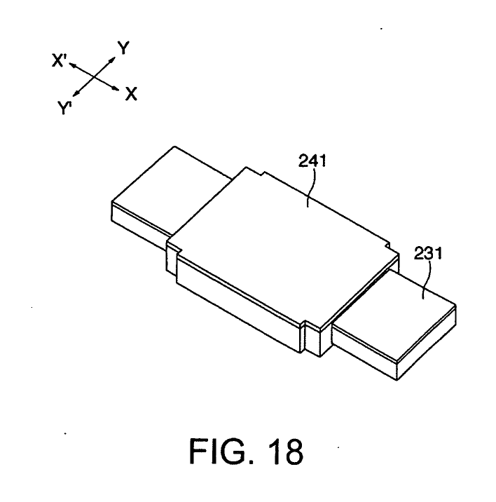

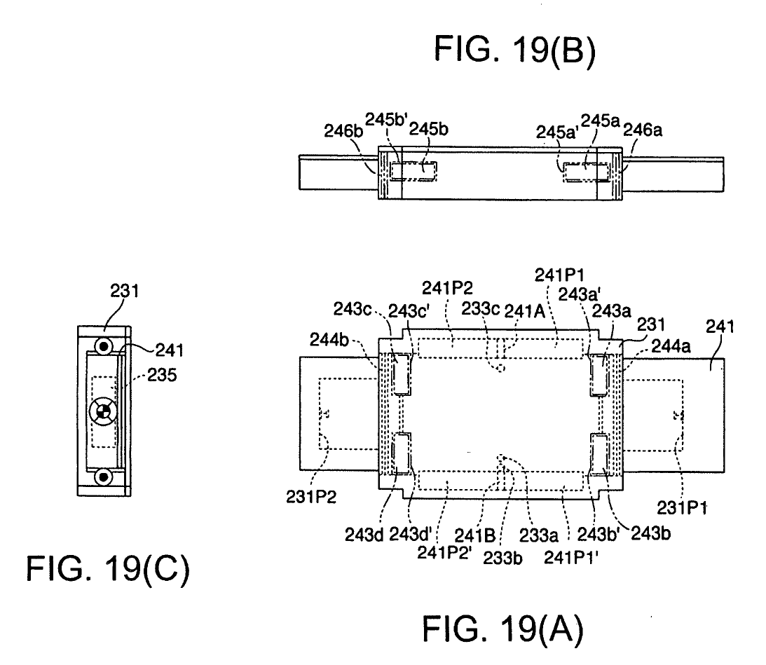

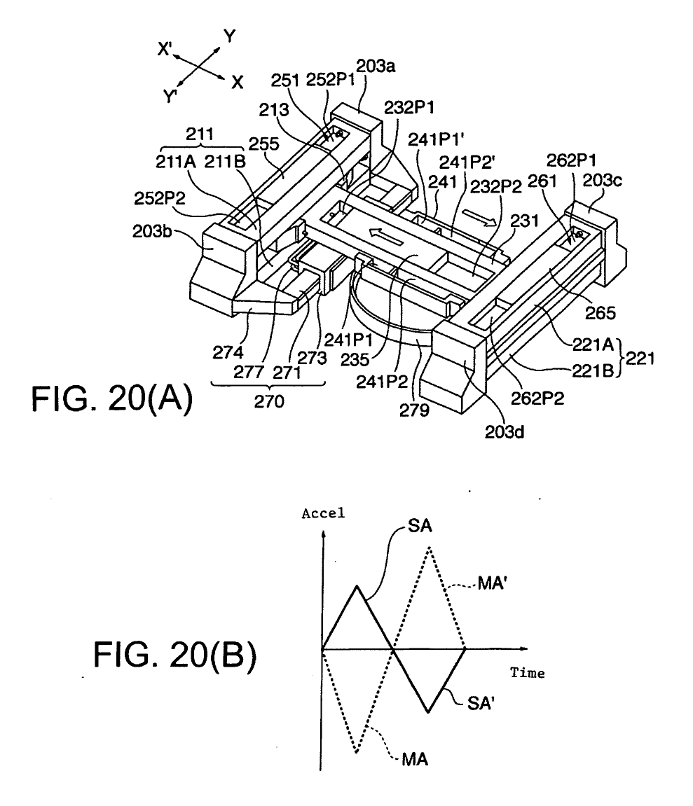

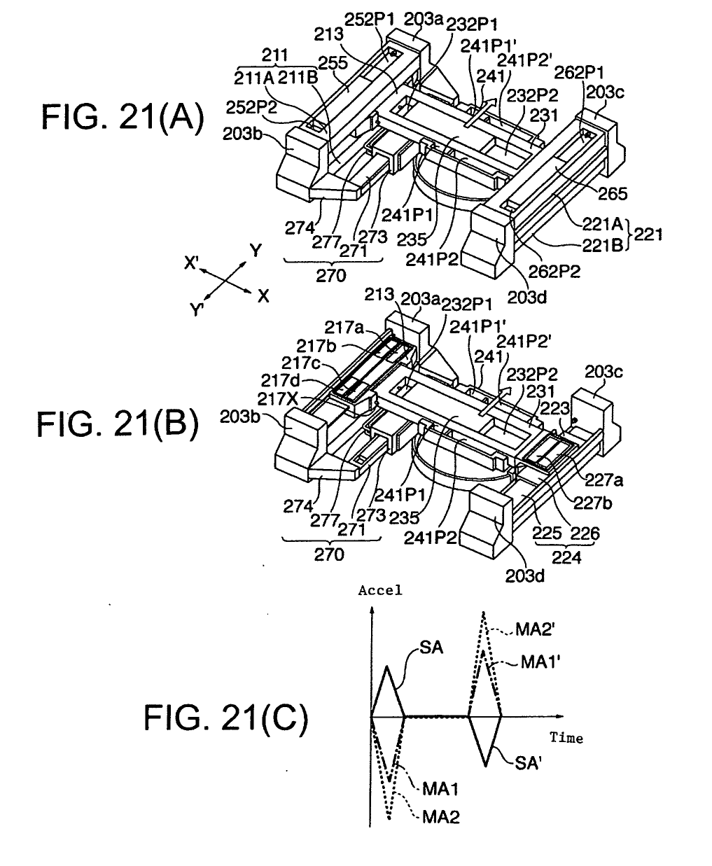

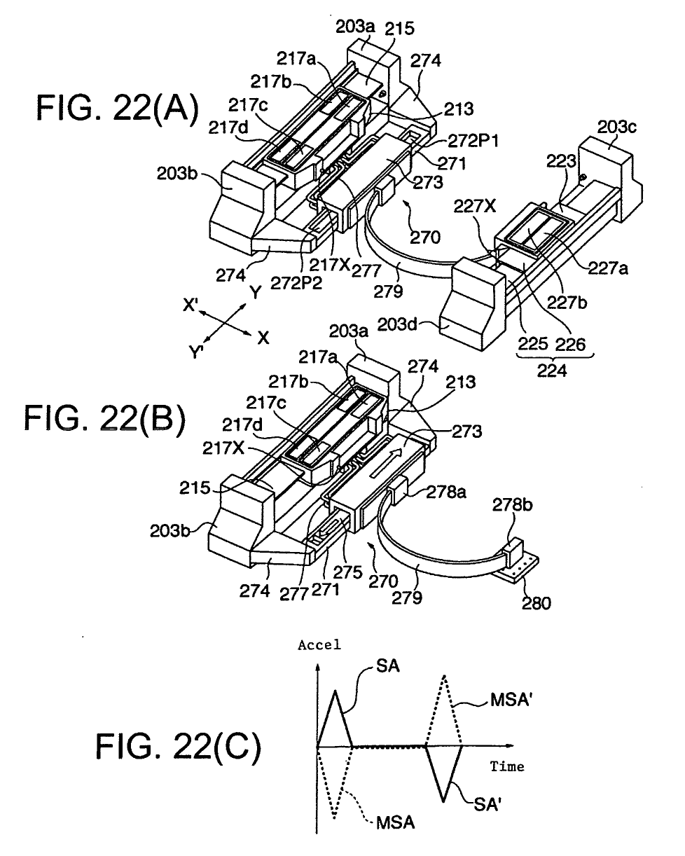

A stage device according to a fifth embodiment is described with reference to FIGS. 13-15, 16(A)-16(C), 17-18, 19(A)-19(C), 20(A)-20(B), 21(A)-21(C), and 22(A)-22(C). FIG. 13 is a perspective view of the overall configuration of the stage device. FIG. 14 is a perspective view of the stage device, with the upper cover removed from the guides and stage(s). FIG. 15 is a perspective view of a linear motor, the Y-slider, the movement guide, and the stage (from which the fixed guides have been removed). FIG. 16(A) is a plan view, FIG. 16(B) is a front elevational view, and FIG. 16(C) is a side elevational view of the parts shown in FIG. 15. FIG. 17 is an exploded perspective view of the interior configuration of the Y-slider-drive linear motor of the stage device. FIG. 18 is a perspective view of a movement guide and stage. FIG. 19(A) is a plan view, FIG. 19(B) is a front elevational view, and FIG. 19(C) is a side elevational view of the movement guide and stage shown FIG. 18. FIG. 20(A) is a perspective view showing stage action in the X-direction, and FIG. 20(B) is a corresponding action graph. FIGS. 21(A) and 21(B) are perspective views of stage action in the Y-direction, and FIG. 21(C) is a corresponding action graph. FIGS. 22(A) and 22(B) are perspective views of line-carrier action, and FIG. 22(C) is a corresponding action graph.

The stage device 201 corresponds to the wafer stage 131 in the exposure system shown in FIG. 6. The stage device 201 is configured so that, in the Y-direction indicated by the arrows at the upper left in FIGS. 13 and 14, continuous movement (scanning) requiring precise stage positioning is performed by linear motors (see FIGS. 15-17). Meanwhile, in the X-direction, intermittent movement and stopping are performed using an air cylinder (see FIG. 19).

As shown in FIGS. 13-14, at the four corners of the stage device 201, four posts 203a-203d are respectively erected on a base that is not shown. Fixed guides 211, 221 that extend mutually in parallel along the Y-direction are respectively suspended between the posts 203a, 203b on the left side and between the posts 203c, 203d on the right side. The fixed guides 211, 221 comprise, respectively, upper and lower guide members 21 1A, 21 1B and 221A, 221B. The upper and lower guide members 21 1A, 211B and 221A, 221B, respectively, are band-shaped members that extend in the Y-direction, and mutually face each other in parallel up and down, separated by a gap.

The Y-sliders 213 (223) shown in FIGS. 15 and 16 are respectively sandwiched between the two guide members 211A, 211B (221A, 22 1B) of the fixed guides 211 (221). The Y-sliders 213, 223 are respectively driven by linear motors 214, 224, and respectively slide along the Y-direction.

A description is given first of the configuration about the periphery of the Y-slider 213 on the left side in FIGS. 16(A) and 16(B). As shown in FIG. 16(B), the main body of the Y-slider 213 has a sideways U-shaped cross section opening outwardly. The linear motor 214 is situated inside the sideways U-shaped opening (channel). In the linear motor 214 a movable coil 216 having a sideways U-shaped vertical cross section is configured so that it can slide relative to a stator 215 having a T-shaped vertical cross-section. The stator 215 is shaped so as to be sandwiched between the two guide members 211A, 211B of the fixed guide 211 shown in FIG. 13, and the stator 215 is positioned such that it extends in the Y-direction. The two ends of the stator 215 are secured to the posts 203a, 203b (see FIGS. 13 and 14). The movable coil 216 is situated such that the sideways U-shaped opening thereof faces outwardly (the left side in FIGS. 16(A) and 16(B)). The outside of the movable coil 216 is secured to the Y-slider 213. The movable coil 216 and the Y-slider 213 form a unit that slides in the Y-direction relative to the stator 215.

As shown at the top of FIG. 17, multiple oval Y-coils 215a are incorporated into the stator 215, aligned along the Y-direction (direction of sliding), and one slender X-coil 215b is situated next to the Y-coils 215a. The Y-coils 215a and the X-coil 215b are self-magnetic-field-canceling coils that function to block disturbed magnetic fields such as high-frequency electromagnetic noise. Multiple rod-shaped, permanent Y-magnets 216a are incorporated in the upper and lower surfaces inside the sideways U-shaped opening in the movable coil 216. The Y-magnets are aligned so that their N and S poles alternate in the Y-direction (direction of sliding). Two long rod-shaped, permanent X-magnets 216b are deployed next to the Y-magnets 216a so that their N and S poles are opposite. The permanent magnets 216a, 216b are self-magnetism-shielded permanent magnets (e.g., Nd—Fe—B type). Thus, these magnets block disturbed magnetic fields such as high-frequency electromagnetic noise.

The permanent Y-magnets 216a correspond to the Y-coils 215a, and these fulfill the role of a Y-axis linear motor that produces a force F_{y} in the Y-direction. The permanent X-magnets 216b correspond to the X-coil 215b, and these, together with the permanent X-magnets 216b′ and X-coil 215b′ described below, fulfill the role of a θ_{z}-yaw linear motor that produces a force Fₓ in the X-direction.

Electrical connecting wires for controlling the Y-coils 215a and X-coil 215b, as well as hydraulic lines for circulating a cooling medium, and the like (not shown) are connected to the fixed guide 211.

As shown best in FIG. 16(A), four air pads 217a-217d are provided in the upper and lower surfaces of the Y-slider 213 (the surfaces that are in opposition to the two guide members 211A and 211B of the fixed guide 211 in FIG. 13), although only the four air pads on the upper sliding surface side are shown in the figure. The air pads 217a-217d are comprised of a porous material. Air is supplied to the air pads 217a-217d from air lines 217X. These air lines 217X are connected to the Y-slider 213 and are connected to an air supply (not shown).

In the sliding surfaces of the Y-slider 213, atmospheric-venting channels 217a′-217d′ are formed about the peripheries of the air pads 217a-217d. In the sliding surfaces of the Y-slider 213 a rectangular vacuum-exhaust channel 218a is formed that encloses the entirety of the air pads 217a-217d. Also formed is a linear vacuum-exhaust channel 218b that extends along the Y-direction. The air pads 217a-217d are divided by the vacuum exhaust channel 218b into two pads on the inside (i.e., 217a and 217c) and two pads on the outside (i.e., 217b and 217d). The inner air pads 217a and 217c and the outer air pads 217b and 217d are configured and arranged such that the volume of air supplied to them can be independently regulated.

The four air pads, the atmospheric-venting channel, and the vacuum-exhaust channel on the lower sliding-surface side are configured in a manner similar to the upper sliding-surface side.

Whenever air is supplied from an air supply (not shown) via the air lines 217X to the air pads 217a-217d, air is discharged from the porous material. By this discharged air, the Y-slider 213 is non-contact supported against the upper and lower guide members 211A and 211B (see FIGS. 13 and 14). The discharged air is released into the ambient atmosphere via the atmospheric-venting channels 217a′-217d′. Air that leaks from the atmospheric-venting channels 217a′-217d′ is vacuum-exhausted via the vacuum-exhaust channels 218a and 218b. Thus, almost no air supplied to the air pads 217a-217d leaks out into the chamber(s) in which a high vacuum is maintained.

As shown in FIG. 16(B), at the end of the stator 215 of the linear motor 214, the permanent X-magnets 216b′ and the X-coil 215b′ that constitute a θ_{z}-yaw linear motor are provided together with the permanent X-magnets 216b and the X-coil 215b described earlier (see FIG. 17). The θ_{z}-yaw linear motor is used for driving the Y-slider 213 in the X-direction by the small dimensions noted earlier. The permanent X-magnets 216b′ and the X-coil 215b′ have two gap sensors (not shown) for detecting displacements of the Y-slider 213 in the X-direction. By controlling the θ_{z}-yaw linear motor while continually detecting displacements of the Y-slider 213 in the X-direction with these gap sensors, attitude control can be performed for the Y-slider 213 and the movement guide 231 about a direction (Z-direction) that is perpendicular to the XY plane.

Next, a description of the configuration of the periphery of the Y-slider 223 on the right side in FIG. 15 is given while referencing mainly FIGS. 15 and 16. As shown in FIG. 16(B), the main body of the Y-slider 223 has a sideways U-shaped cross-section that opens outwardly. A linear motor 224 is situated inside the sideways U-shaped opening (channel). In the linear motor 224, a movable coil 226 having a sideways U-shaped vertical cross section is configured to slide relative to a stator 225 having a T-shaped vertical cross-section. The stator 225 is shaped so as to be sandwiched between the two guide members 221A, 221B of the fixed guide 221 (FIG. 13), and is positioned so as to extend in the Y-direction. The two ends of the stator 225 are secured to the posts 203c, 203d (see FIGS. 13 and 14). The movable coil 226 is positioned such that the sideways U-shaped opening thereof faces outwardly (the right side in FIGS. 16(A) and 16(B)), which is the side opposite that of the movable coil 216 of the linear motor 214 described above. The outside of the movable coil 226 is secured to the Y-slider 223. The movable coil 226 and the Y-slider 223 form a unit that slides in the Y-direction relative to the stator 225. In the stator 225 and movable coil 226, as in the stator 215 and movable coil 216 described above, self-magnetic-field-canceling coils and self-magnetism-shielded permanent magnets as shown in FIG. 17 are provided.

As shown in FIGS. 15 and 16(A), two air pads 227a and 227b are provided in each of the upper and lower surfaces (the surfaces in opposition to the two guide members 221A and 221B of the fixed guide 221 shown in FIG. 13) of the Y-slider 223 (although only the two air pads on the upper sliding surface side are shown in the drawing). The air pads 227a-227d comprise a porous material. Air is supplied to the air pads 227a-227d from air lines 227X. The air lines 227X are connected to the Y-slider 223, and are connected to an air supply that is not shown.

In the sliding surfaces of the Y-slider 223, atmospheric-venting channels 227a′, 227b′ are formed peripherally around the air pads 227a, 227b. In the sliding surfaces of the Y-slider 223 are formed a rectangular vacuum-exhaust channel 228a that circumscribes the air pads 227a, 227b, and a linear vacuum-exhaust channel 228b that extends in the Y-direction between the air pads 227a, 227b. By the vacuum-exhaust channel 228b, the air pads 227a, 227b are divided between air pad 227b on the inside, and air pad 227a on the outside. The outer air pad 227a and the inner air pad 227b are configured and arranged to allow the volume of air supplied to them to be independently regulated. Also, on the Y-slider 223 side and by the same action as described earlier, the Y-slider 223 is non-contact supported against the upper and lower guide members 221A and 221B (see FIGS. 13 and 14).

The two air pads, the atmospheric-venting channel, and the vacuum-exhaust channel on the lower sliding-surface side are configured in a similar manner as corresponding features on the upper sliding-surface side.

Next, the movement guide 231 and stage 241 between the two Y-sliders 213, 223 are described. As shown in FIGS. 13-16 and 18, the movement guide 231 extending in the X-direction is suspended between the two Y-sliders 213, 223. A stage 241 (X-slider) is attached to the movement guide 231 in a manner allowing sliding motion of the stage. Motion of the stage 241 is guided by the movement guide 231, with four surfaces (upper, lower, and two side surfaces that are sliding surfaces) being constrained. Hence, sliding of the stage 241 is performed more stably. Onto the same stage 241 are mounted a micro-movement table and a wafer chuck and the like (not shown).

As described earlier, in the Y-slider 213, the two inside air pads 217a, 217c and the two outside air pads 217b, 217d are positioned so as to be aligned in the Y-slider 223. Also, the outside air pad 227a and the inside air pad 227b are aligned. Thus, by applying a downward force (gas pressure) from the outside air pads 217a, 217c, 227a on the movement guide 231, and applying an upward force (gas pressure) from the inside air pads 217b, 217d, 227b on the movement guide 231, the movement guide 231 experiencing any sagging under its own weight is subjected to a bending force that serves to correct the attitude of the movement guide and thus makes the movement guide substantially straight as desired. Besides the forces described above, a floating force is imparted to the Y-sliders 213, 223 because the air pads are static-pressure supporting.

The stage 241 is shaped as a flat box having a hollow portion extending through it, and the inner surfaces of the hollow portion are fitted onto the outer surfaces of the movement guide 231. As shown in FIG. 19(A), each of the upper and lower surfaces (the surfaces that slide over the movement guide 231) of the hollow portion of the stage 241 is provided with four air pads 243a-243d (although only the four air pads on the upper-surface side are shown in the figure). The air pads 243a-243d each comprise a porous material through which gas is discharged. In the sliding surfaces of the stage 241, about the periphery of the air pads 243a-243d, atmospheric-venting channels 243a′-243d′ are defined. Also, vacuum exhaust channels 244a, 244b are formed in the vicinity of the two ends of the sliding surfaces of the stage 241.

The respective four air pads, the atmospheric-venting channels, and the vacuum-exhaust channels on the lower sliding-surface side are configured in the same manner as on the upper sliding-surface side.

As shown in FIG. 19(B), two air pads 245a, 245b are provided in each of the side surfaces of the hollow portion (the surfaces that slide on the movement guide 231) of the stage 241 (although only the two respective air pads on one surface are shown in the figure). The air pads 245a, 245b comprise a porous material through which gas is discharged. Atmospheric-venting channels 245a′, 245b′ are defined in the sliding surfaces of the stage 241, about the periphery of the air pads 245a, 245b. Also, vacuum-exhaust channels 246a, 246b are defined in the vicinity of the two ends of the sliding surfaces of the stage 241.

The respective two air pads, atmospheric-venting channels, and vacuum-exhaust channels on the one sliding-surface side are configured in the same manner as on the upper sliding-surface side.

As shown in FIGS. 19(A) and 19(C), an atmospheric-venting hole 233b, a vacuum-exhaust hole 233c, and an air-supply hole 233a for the air pads are defined in the center portion of the movement guide 231. The air-supply hole 233a is connected to the air pads, and air supplied from the air-supply hole 233a is discharged from the porous material of each air pad. The atmospheric-venting hole 233b is connected to the atmospheric-venting channels 245a′, 245b′. Air discharged from the air pads passes from the atmospheric-venting channels 245a′, 245b′ through the air-exhaust hole 233b and is released into the ambient atmosphere. The vacuum-exhaust hole 233c is connected to the vacuum-exhaust channels 246a, 246b. Any air that leaks from the atmospheric-venting channels 245a′, 245b′ passes through the vacuum-exhaust channels 246a, 246b and is vacuum-exhausted from the vacuum-exhaust hole 233c. By the air discharged from the air pads, the stage 241 is non-contact supported on the movement guide 231 while four surfaces of are constricted.

Next, an air-cylinder drive mechanism for the X-slider is described. As shown in FIG. 19(A), the stage 241 has a gas chamber 241P on the side of the inner hollow portion. Partition panels 241A, 241B are provided in the center of the gas chamber 241P. Thus, the gas chamber 241P is divided into two adjacent gas chambers 241P1 and 241P2 by the partition panel 241A, and into two adjacent gas chambers 241P1′ and 241P2′ by the partition panel 241B. The gas chambers 241P1, 241P1′, and the gas chambers 241P2, 241P2′, respectively, are mutually connected. In the interior of the movement guide 231, conduits (not shown) are provided for supplying gas to the gas chambers 241P1, 241P1′ and 241P2, 242P2′. These conduits include pressurized-air-control valves (not shown) that serve to control the pressure of the gas supplied into the gas chambers. By effecting differences in the pressures in the adjacent gas chambers 241P1, 241P1′, and 241P2, 242P2′, the stage 241 can be driven in the X-direction (as described in detail below).

Next, the configuration of active countermasses installed in the fixed guides 211 and 221, and in the movement guide 231, is described. The active countermasses incorporated inside the fixed guides 211 and 221 are described first. As shown in FIG. 14, in each of the upper and lower guide members 211A, 211B of the fixed guide 211, a pressure chamber 252 is defined (e.g., by machining), although only the upper guide member 211A is shown in the figure. Inside the pressure chamber 252, a pressure-receiving body (countermass) 255 is deployed. The pressure-receiving body 255 is configured such that its length is shorter than the length of the pressure chamber 252, while its width is substantially the same as the width of the pressure chamber 252. Pressure chambers 252P1 (Y-direction side) and 252P2 (Y′-direction side) are formed inside the pressure chamber 252 at the two ends, respectively, of the pressure-receiving body 255. Air is supplied into the pressure chambers 252P1, 252P2 as a drive source for the pressure-receiving body 255. The air enters through a line 277 of a line carrier 270 described further below.

A similar respective pressure chamber 262 is formed (e.g., by machining) in each of the upper and lower guide members 221A, 221B of the fixed guide 221. (In the figure, only the pressure chamber on the upper guide member 221A side is shown.) A pressure-receiving body (countermass) 265 is deployed inside the pressure chamber 262. The pressure-receiving body 265 is configured such that its length is shorter than the length of the pressure chamber 262, while its width is substantially the same as the width of the pressure chamber 262. Pressure chambers 262P1 I(Y-direction side) and 262P2 (Y′-direction side) are formed inside the pressure chamber 262 at the two ends of the pressure-receiving body 265. Air is supplied into the pressure chambers 262P1, 262P2 as a drive source for the pressure-receiving body 265. Air is supplied through a tube 279 of a line carrier to be described further below.

In the lower guide members 211B, 221B also, pressure chambers and pressure-receiving bodies like those in the upper side are provided.

Next, an active countermass installed in the movement guide 231 is described. As shown in FIG. 14, on the upper-surface side of the movement guide 231, a pressure chamber 232 is formed (e.g., by machining). A pressure-receiving body (countermass) 235 is deployed inside the pressure chamber 232. The pressure-receiving body 235 is configured such that its length is shorter than the length of the pressure chamber 232, while its width is substantially the same as the width of the pressure chamber 232. Pressure chambers 232P1 (X-direction side) and 232P2 (X′-direction side) are formed in the interior of the pressure chamber 232 at the two ends, respectively, of the pressure-receiving body 235. Air is supplied into the pressure chambers 232P1, 232P2 as a drive source for the pressure-receiving body 235. Air is supplied through a flow path (not shown) formed inside the movement guide 231.

The action of the active countermasses in the fixed guides 211, 221 and in movement guide 231 is described later below.

Next, the line carrier 270 shown FIGS. 13, 14, 20(A), 21(B), and 22(A)-22(B) is described as follows. As shown best in FIGS. 22(A) and 22(B), support members 274 (which protrude toward the inside in the X-direction) are respectively secured to the lower-end parts of the posts 203a and 203b at the two places on the left side. A secondary fixed guide 271 is suspended, parallel to the fixed guide 211, between the support members 274 at the two places. An auxiliary slider 273 is attached to this secondary fixed guide 271. The auxiliary slider 273 can slide with the four surfaces thereof (upper, lower, and two side surfaces) being constrained. An air cylinder is situated inside the auxiliary slider 273. Multiple lines 277 are connected between the auxiliary slider 273 and the Y-slider 213. These lines 277 mediate the flowing in and out of air used as the driving source for the active countermass in the fixed guide 211 and of air for the non-contact gas bearings. The auxiliary slider 273 slides and is positioned on the secondary fixed guide 271 closely along the Y-slider 213.

Referring to FIGS. 22(A)-22(B), on the upper-surface side of the secondary fixed guide 271, a pressure chamber 272 is formed (e.g., by machining). A pressure-receiving body (countermass) 275 is deployed inside the pressure chamber 272. The pressure-receiving body 275 is formed such that its length is shorter than the length of the pressure chamber 272, while its width is substantially the same as the width of the pressure chamber 272. Pressure chambers 272P1 (Y-direction side) and 272P2 (Y′-direction side) are formed inside the pressure chamber 272 at the two ends, respectively, of the pressure-receiving body 275. Air is supplied into the pressure chambers 272P1, 272P2 as a drive source for the pressure-receiving body 275.

A tube 279 is connected to the side surface of the auxiliary slider 273. In FIG. 22(B) one end unit 278a of the tube 279 is secured to the auxiliary slider 273, while the other end unit 278b of the tube is secured to an attachment plate 280 on a base (not shown). The tube 279 is made of a flexible material. Air lines and electrical connecting wires and the like are situated inside the tube. Air is supplied via the tube 279 as the drive source for the active countermass of the fixed guide 221 and to supply air for the non-contact gas bearings.

The action of the stage device 1 is described with reference to FIGS. 20-22. First, the X-direction movement of the stage 241 along the movement guide 231 is described. As shown in FIG. 20(A), the stage 241 (by action of the air-cylinder mechanism, i.e., pressure operations of the gas chamber 241P inside the stage 241) performs step actions that are limited to intermittent movement and stopping. When the stage 241 is moved in the X-direction along the movement guide 231, air is exhausted from the gas chambers 241P1, 241P1′ while being supplied to the gas chambers 241P2, 241P2′. Thus, the internal pressure in the gas chambers 241P2, 241P2′ becomes higher than the internal pressure in the gas chambers 241P1, 241P1′, causing the stage 241 to move in the X-direction on the right side in FIG. 20(A).

Meanwhile, with respect to the active countermass inside the movement guide 231, air is supplied to the pressure chamber 232P2 while being exhausted from the pressure chamber 232P1, causing the pressure-receiving body 235 to be moved in a direction (X′-direction) opposite to the direction (X-direction) of movement of the stage 241. Thus, as shown in FIG. 20(B), the pressure-receiving body 235 acts in a manner such that the acceleration MA (broken line) of the pressure-receiving body 235 becomes larger than the acceleration SA (solid line) of the stage 241. Also, the acceleration MA is oriented in a direction opposite to the acceleration SA. Consequently, the recoil that develops in conjunction with the movement of the stage 241 can be canceled by the action of the pressure-receiving body 235, thereby providing high positional precision in the stage 241.

Whenever the stage 241 is moved in the X′-direction, (opposite to what was described above) air is supplied to the gas chambers 241P1, 241P1′ while being exhausted from the gas chambers 241P2, 241P1′. Meanwhile, with respect to the active countermass, air is exhausted from the pressure chamber 232P2 while being supplied to the pressure chamber 232P 1. Thus, as shown in FIG. 20(B), the pressure-receiving body 235 is made to act such that the acceleration MA′ of the pressure-receiving body 235 becomes larger than the acceleration SA′ of the stage 241. Also, the acceleration MA′ is oriented in a direction opposite to the direction of the acceleration SA′.

With respect to the Y-direction movement of the movement guide 231 and the stage 241 due to sliding of the Y-sliders 213 and 223, as shown in FIGS. 21 and 22, the Y-sliders 213, 223, movement guide 231, and stage 241 perform continuous movement (scanning movements) requiring precise positioning by the linear motors 214, 224 (see also FIGS. 15-17). When the movement guide 231 and stage 241 are driven in the Y-direction along the fixed guides 211, 221, current flows to the linear motors 214, 224, and the movable coils 216, 226 are made to slide in the Y-direction relative to the stators 215, 225 (see also FIG. 17). Thus, the Y-sliders 213, 223 integrated with the movable coils 216, 226 slide in the Y-direction along the fixed guides 211, 221, and the movement guide 231 and stage 241 move in the Y-direction. Simultaneously with the movement of the Y-slider 213, the auxiliary slider 273 for the line carrier also moves in the Y-direction along the secondary fixed guide 271.

Meanwhile, with respect to the active countermass of the fixed guide 211, air is supplied to the pressure chamber 252P1 while being exhausted from the pressure chamber 252P2, causing movement of the pressure-receiving body 255 in a direction (Y′-direction) opposite the direction (Y-direction) of movement of the movement guide 231 and stage 241. With respect to the active countermass of the fixed guide 221, air is supplied to the pressure chamber 262P1 while being exhausted from the pressure chamber 262P2, causing movement of the pressure-receiving body 265 in a direction (Y′-direction) opposite the direction (Y-direction) of movement of the movement guide 231 and stage 241. The active countermasses of these two fixed guides 211, 221 act separately on the pressure-receiving bodies 255 and 265 such that, as shown in FIG. 21(C), the acceleration MA1 (chain line) of the pressure-receiving body 255 becomes larger than the acceleration SA (solid line) of the stage 241 and is oriented in a direction opposite the direction of the acceleration SA. Consequently, the acceleration MA2 (broken line) of the pressure-receiving body 265 becomes even larger than the acceleration MA1.

Meanwhile, in the active countermass of the line carrier, the pressure-receiving body 275 is made to act so that, as shown in FIG. 22(C), the acceleration MSA (broken line) of the pressure-receiving body 275 becomes slightly larger than the acceleration SA (solid line) of the stage 241 and is oriented in a direction opposite the direction of the acceleration SA.

Due to the actions of these active countermasses, any recoil that develops in conjunction with movement of the movement guide 231 and stage 241 is canceled by corresponding motions of the pressure-receiving bodies 255, 265, 275. Thus, high positional precision in the stage 241 is realized.

Whenever the stage 241 is moved in the Y′-direction, the linear motors are activated in a direction opposite to that described above, and the active countermasses also act opposite to that described above. Hence, the pressure-receiving bodies 255, 265 are made to act separately so that, as shown in FIG. 21(C), the acceleration MA1′ (chain line) of the pressure-receiving body 255 becomes larger than the acceleration SA′ (solid line) of the stage 241 and is oriented in a direction opposite to the acceleration SA′. Consequently, the acceleration MA2′ (broken line) of the pressure-receiving body 265 becomes even larger than the acceleration MA1′. Meanwhile, in the active countermass of the line carrier, as shown in FIG. 22(C), the pressure-receiving body 275 is made to act so that the acceleration MSA′ (broken line) of the pressure-receiving body 275 becomes slightly larger than the acceleration SA′ (solid line) of the stage 241 and is oriented in a direction opposite to the acceleration SA′.

During the action of such a stage 241 and its active countermasses, as shown in FIG. 16(B), the positions of the centers of gravity of the drive points α for the linear motors 214, 224 of the Y-sliders 213, 223 substantially coincide in the vertical direction with the positions of the centers of gravity of the drive points β for the pressure-receiving bodies 255, 265 of the upper and lower active countermasses. For that reason, drive forces can be imparted to the centers of gravity of the Y-sliders 213, 223, and high-precision, high-speed position control is realized.

Thus, with the stage device 1 of this embodiment, by combining the actions in the X-direction and Y-direction as described above, the stage 241 can be moved and positioned with high precision in the XY plane. The stroke in one example is 400 mm, with a compensatory stroke of 350 mm.

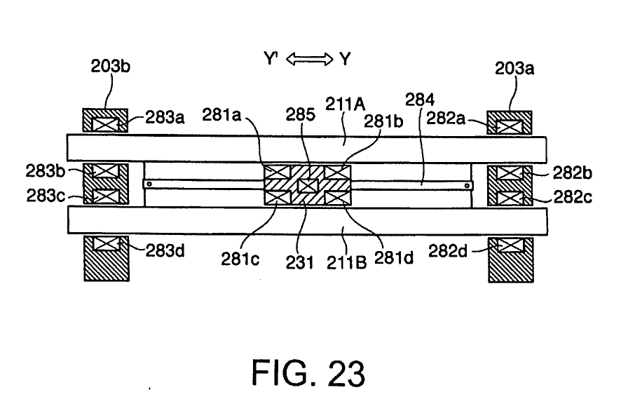

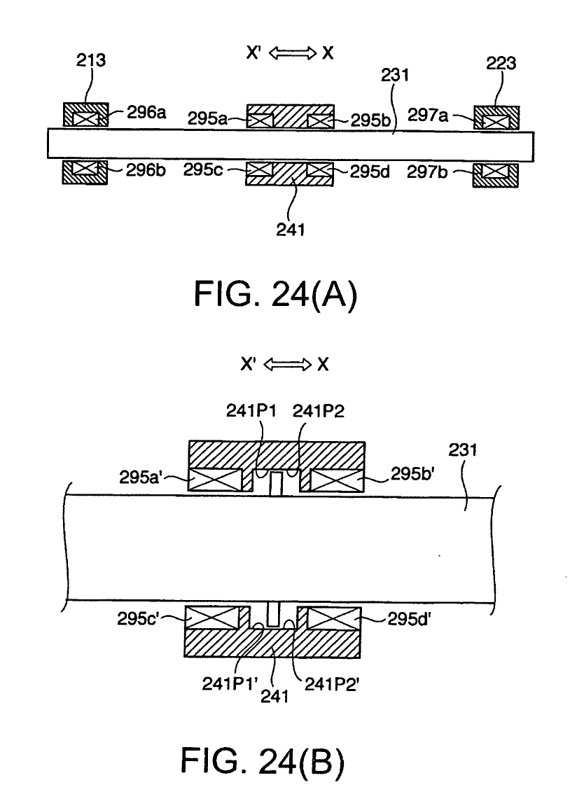

In the embodiments described above, descriptions are given for cases in which a recoil-disposing mechanism employing active countermasses was used. However, a passive-countermass mechanism, as shown in FIGS. 23 and 24, alternatively can be adopted. FIG. 23 depicts an exemplary configuration of a passive-countermass mechanism for a Y-direction drive. FIGS. 24(A)-24(B) depict an exemplary configuration of a passive-countermass mechanism for an X-direction drive, wherein FIG. 24(A) is a side elevational view, and FIG. 24(B) is a plan view.

The exemplary Y-direction passive-countermass mechanism is described first, with reference to FIG. 23. The upper guide member 211A and lower guide member 211B are non-contact supported by posts 203a, 203b via non-contact gas bearings (air pads) 282a-282d and 283a-283d, and can slide in the Y-direction. Between the upper and lower guide members 211A, 211B, the Y-slider 213 is non-contact supported by non-contact gas bearings (air pads) 281a-281d. For these non-contacting gas bearings, air pads and exhaust channels similar to those described earlier can be used. A linear-motor stator 284 is attached to each of the guide members 211A, 211B. A movement coil 285 is incorporated in each linear-motor stator 284. Thus, whenever the Y-slider 213 is driven, its recoil acts from the stator 284 to the guide members 211A, 211B.

In a passive-countermass mechanism such as this, whenever the Y-slider 213 (stage 241) slides in the Y-direction, the drive recoil of the Y-slider 213 causes the upper and lower guide members 211A and 211B to be driven in a direction (Y′-direction) opposite to the posts 203a and 203b. Thus, the recoil occurring whenever the Y-slider (stage) is driven in the Y-direction can be canceled. Conversely, whenever the Y-slider 213 slides in the Y′-direction, the upper and lower guide members 211A and 211B are driven in the Y-direction relative to the posts 203a and 203b. Thus, the recoil occurring whenever the Y-slider is driven in the Y′-direction also is cancelled.

Between the posts 203a and 203b, on the one hand, and the guide members 211A and 211B, on the other hand, a position-return mechanism comprising a weak flat spring or the like is provided. Thus, the guide members 211A and 211B will not move beyond the design stroke.

Next, an example of an X-direction passive countermass mechanism is described with reference to FIGS. 24(A)-24(B). The movement guide 231 is non-contact supported by the Y-sliders 213, 223 via non-contacting gas bearings (air pads) 296a, 296b and 297a, 297b, and can slide in the X-direction. On the movement guide 231, the stage 241 is non-contact supported by non-contact gas bearings (air pads) 295a-295d (upper and lower surfaces: see FIG. 24(A)) and 295a′-295d′ (side surfaces: see FIG. 24(B)). For these non-contacting gas bearings, air pads and exhaust channels similar to those described earlier can be used.

In a passive-countermass mechanism such as this, whenever air is exhausted from the gas chambers 241P1, 241P1′ inside the stage 241 while air is being supplied to the gas chambers 241P2, 241P2′, and the stage 241 slides in the X-direction, the drive recoil of the stage 241 causes the movement guide 231 to be driven in a direction (X′-direction) opposite the direction of motion of the Y-sliders 213, 223. Thus, recoil occurring whenever the stage 241 is being driven in the X-direction can be canceled. Conversely, whenever the stage 241 slides in the X′-direction, the movement guide 231 is driven in the X-direction, which cancels any recoil caused by motion of the stage 241.

As is clear from the foregoing description, stage devices and the like are provided that can be made small and lightweight and that produce little magnetic-field disturbance. As a result, high-precision scan positioning can be performed.

1. A stage device for driving and positioning a stage in an XY plane, comprising:
fixed guides extending in a Y-direction in the XY plane;
two Y-sliders that slide on the fixed guides;
a drive mechanism for the Y-sliders;
a movement guide suspended between the Y-sliders and extending in an X-direction in the XY plane;
an X-slider that slides on the movement guide;
a drive mechanism for the X-slider; and
a stage unit mounted on the X-slider;
wherein the Y-slider drive mechanism includes respective actuators for each Y-slider, each actuator being a linear motor having a permanent-magnet stator secured along the respective fixed guide; and
the X-slider drive mechanism includes a respective actuator that is a non-electromagnetic-force actuator.

2. A stage device for driving and positioning a stage in an XY plane, comprising:
fixed guides extending in a Y-direction in the XY plane;
two Y-sliders that slide on the fixed guides;
a drive mechanism for the Y-sliders;
a movement guide suspended between the Y-sliders and extending in an X-direction in the XY plane;
an X-slider that slides on the movement guide;
a drive mechanism for the X-slider; and
a stage unit mounted on the X-slider; ‘wherein the Y-slider drive mechanism includes respective actuators for each Y-slider, each actuator being a linear motor; and
the X-slider drive mechanism includes a respective actuator that is an air cylinder.

3. The stage device of claim 1, wherein:
a first table driven in a θ_{z}-direction (about a Z-axis) is mounted on the stage unit; and
a second table driven in a θₓ-direction (about an X-axis), a θ_{y}-direction (about a Y-axis), and a Z-direction is mounted on the first table.

4. The stage device of claim 1, wherein the actuator of the X-slider drive mechanism includes a movable part that is guided by at least one gas bearing (at least one air pad).

5. The stage device of claim 1, wherein:
the non-electromagnetic-force actuator is an air cylinder, and
a pressurized-air-control valve for regulating air pressure in the air cylinder is mounted on the movement guide.

6. The stage device of claim 1, wherein:
the two Y-sliders are guided by the fixed guides with only upper and lower sliding surfaces of the Y-sliders being constrained; and
the stage is turnable in a θ_{z}-direction (about a Z-axis) by adjusting a propulsion distribution of the linear motors.

7. The stage device of claim 1, further comprising:
a secondary fixed guide positioned parallel to the fixed guides;
an auxiliary slider guided on the secondary fixed guide, the auxiliary slider having upper, lower, and two side sliding surfaces that are constrained, by at least one gas bearing; and
connection means, flexible in the X-direction and rigid in the Y-direction, for connecting the auxiliary slider and the Y-sliders, wherein stage recoil arising whenever the stage is driven in the X-direction is cancelled according to the law of the conservation of momentum.

8. The stage device of claim 7, wherein the connection means comprises at least one spring that is flexible in the X-direction and rigid in the Y-direction.

9. An exposure system, comprising:
a mask stage for mounting a mask on which a desired pattern has been formed;
an illumination-optical system for illuminating the mask with an energy beam;
a sensitive-substrate stage for mounting a sensitive substrate onto which the pattern is to be transferred;
a projection-optical system for projecting the energy beam, after having passed through the mask, onto the sensitive substrate and forming an image; and
control means for controlling the stages and optical systems so as to obtain exposures while synchronously scanning the stages along a Y-direction;
wherein at least one of the mask stage and sensitive-substrate stage comprises fixed guides extending in the Y-direction, two Y-sliders that slide on the fixed guides, a drive mechanism for the Y-sliders, a movement guide extending in an X-direction and being suspended between the two Y-sliders, an X-slider that slides on the movement guide, a drive mechanism for the X-slider, and a stage unit mounted on the X-slider, wherein the Y-slider drive mechanism includes an actuator that is a linear motor having at least one permanent-magnet stator secured along the fixed guides, and the X-slider drive mechanism includes an actuator that is a non-electromagnetic-force actuator.

10. An exposure system, comprising:
a mask stage for mounting a mask on which a desired pattern has been formed;
an illumination-optical system for illuminating the mask with an energy beam;
a sensitive-substrate stage for mounting a sensitive substrate onto which the pattern is to be transferred;
a projection-optical system for projecting an energy beam, after having passed through the mask, onto the sensitive substrate and forming an image; and
control means for controlling the stages and optical systems such that the exposure system performs exposures while synchronously scanning the stages in a Y-direction; wherein at least one of the mask stage and substrate stage comprises fixed guides extending in the Y-direction, two Y sliders that slide on the fixed guides, a drive mechanism for the Y-sliders, a movement guide suspended between the Y-sliders and extending in an X-direction, an X-slider that slides on the movement guide, a drive mechanism for the X-slider, and a stage unit mounted on the X-slider, wherein the Y-slider drive mechanism comprises an actuator that is a linear motor, and the X-slider drive mechanism comprises an actuator that is an air cylinder.

11. The exposure system of claim 9, wherein;
a first table, driven in a θₓ-direction (about a Z-axis) is mounted on the stage unit; and
a second table, driven in a θₓ-direction (about an X-axis), a θ_{y}-direction (about a Y-axis), and a Z-direction is mounted on the first table.

12. A stage device for driving and positioning a stage in an XY plane, for performing continuous scanning movements requiring precise positioning in one direction (Y-direction) in the XY plane, and for performing intermittent movements and stopping in another direction (X-direction) in the XY plane, the stage device comprising:
two fixed guides extending in the Y-direction;
two Y-sliders that severally slide along the fixed guides;
a drive mechanism for the Y-sliders;
a movement guide extending in the X-direction and being suspended between the two Y-sliders;
a stage (X-slider) that slides along the movement guide; and
a drive mechanism for the stage;
wherein the Y-slider drive mechanism comprises an actuator that is a linear motor; and
the stage-drive mechanism comprises an actuator that is an air cylinder.

13. The stage device of claim 12, wherein:
the fixed guides have upper and lower guide members for sandwiching the Y-sliders from above and below; and
non-contacting gas bearings are deployed between respective upper and lower surfaces of the two guide members and the Y-sliders.

14. The stage device of claim 12, wherein:
no guide mechanism is provided between the fixed guides and the Y-sliders that constrain the sliders in said X direction;
a linear motor (linear motor) for small-dimensionally driving in the X-direction is attached to the Y-drive linear motor; and
attitudes of the Y-sliders and movement guide about a direction (Z-direction) perpendicular to the XY plane are controlled by the θ_{z}-yaw linear motor.

15. The stage device of claim 12, wherein the stage is guided on the movement guide with four surfaces (upper, lower, and two side surfaces) thereof being constrained.

16. The stage device of claim 13, further comprising at least one exhaust channel located on a periphery of the non-contacting gas bearings.

17. The stage device of claim 13, wherein a gas-supplying, atmospheric-venting, and vacuum-exhausting system is provided in one or more of the fixed guides and movement guide.

18. A stage device for driving and positioning a stage in an XY plane, comprising:
two fixed guides extending in a Y-direction in the XY plane;
two Y-sliders that severally slide along the fixed guides;
a drive mechanism for the Y-sliders;
a movement guide extending in an X-direction in the XY plane and being suspended between the two Y-sliders;
a stage (X-slider) that slides along the movement guide; and
a drive mechanism for the stage;
wherein the fixed guides each have respective upper and lower guide members for sandwiching the Y-sliders from above and below;
the guide members receive drive recoil of the Y-sliders; and
an active countermass, that is driven in an opposite direction from the movement direction of the Y-sliders, and a drive mechanism for the active countermass, are deployed inside the guide members.

19. A stage device for driving and positioning a stage in an XY plane, the stage device comprising:
two fixed guides extending in a Y-direction in the XY plane;
two Y-sliders that severally slide along the fixed guides;
a drive mechanism for the Y-sliders;
a movement guide extending in an X-direction in the XY plane and being suspended between the two Y-sliders;
a stage (X-slider) that slides along the movement guide; and
a drive mechanism for the stage;
wherein the fixed guides each include respective upper and lower guide members for sandwiching the Y-sliders from above and below;
the guide members receive drive recoil of the Y-sliders; and
a passive countermass mechanism is configured such that the guide members are non-contact supported against a base of the stage device, and, by the drive recoil of the Y-sliders, the guide members move in an opposite direction from the motion direction of the Y-sliders.

20. The stage device of claim 18, wherein:
the movement guide receives drive recoil of the stage (X-slider); and
an active countermass, that is driven in an opposite direction from the motion direction of the stage, and a drive mechanism for the active countermass, are deployed inside the movement guide.

21. The stage device of claim 18, wherein:
the movement guide receives drive recoil of the stage (X-slider); and
a passive countermass mechanism is configured such that the movement guide is non-contact supported against the Y-sliders, and, by the drive recoil of the stage, the movement guide moves in an opposite direction from the motion direction of the stage.

22. The stage device of claim 18, wherein the actuator of the countermass-drive mechanism is an air cylinder.

23. The stage device of claim 12, further comprising:
an auxiliary slider that moves closely along the Y-sliders; and
a pipeline, connected to the auxiliary slider and to the Y-sliders, for mediating fluid flow into and out of the Y-sliders and auxiliary slider.

24. The stage device of claim 23, further comprising:
a secondary fixed guide, for guiding the auxiliary slider, positioned in parallel with the fixed guides; and
an active countermass, and drive mechanism therefor, deployed inside the secondary fixed guide so as to drive the countermass in an opposite direction from the motion direction of the auxiliary slider.

25. The stage device of claim 21, further comprising a magnetic-shielding structure attached to the linear motor.

26. A stage device for driving and positioning a stage in an XY plane, comprising:
two fixed guides extending in a Y-direction in the XY plane;
two Y-sliders that respectively slide along the fixed guides;
a drive mechanism for the Y-sliders;
a movement guide extending in an X-direction in the XY plane and being suspended between the two Y-sliders;
a stage (X-slider) that slides along the movement guide; and
a drive mechanism for the stage;
wherein a plurality of non-contacting gas bearings are positioned, aligned in the X-direction, and a gas supply to the non-contacting gas bearings is adjusted, so as to correct sagging of the movement guide under its own weight.

27. An exposure system, comprising:
a master-plate stage for mounting a master plate on which a desired pattern has been formed;
an illumination-optical system for illuminating the master plate with an energy beam;
a sensitive-substrate stage for mounting a sensitive substrate onto which the pattern is to be transferred; and
a projection-optical system for projecting the energy beam that has passed through the master plate onto the sensitive substrate and forming an image;
the exposure system being configured for making exposures while synchronously and continuously moving (synchronously scanning) the stages in one direction (Y-direction);
wherein at least one of the stages comprises a stage device as recited in claim 21.

28. An exposure system for selectively illuminating a sensitive substrate with an energy beam and forming a pattern, the exposure system comprising at least one of a sensitive-substrate stage for mounting and moving a sensitive substrate and a master-plate stage for mounting and moving a pattern-master plate, wherein at least one stage comprises a stage device as recited in claim 18.
